(19) United States
(12) Patent Application Publication
(10) Pub. No.: US 2016/0070832 A1
(43) Pub. Date: Mar. 10, 2016

(54) MODELING SYSTEM AND METHOD FOR MODELING A PROCESS OR SYSTEM

(71) Applicant: Michael Boahene, Newport (AU)

(72) Inventor: Michael Boahene, Newport (AU)

(21) Appl. No.: 14/800,683

(22) Filed: Jul. 15, 2015

(30) Foreign Application Priority Data
Jul. 18, 2014 (AU) 2014902790

(51) Int. Cl. G06F 17/50

(52) U.S. Cl. CPC G06F 17/509

(57) ABSTRACT

A modeling system for modeling a process or system comprising a processor arranged to execute a user-interface module and to receive input commands from a user, wherein the user-interface module facilitates the building of a model from the input commands, wherein the model includes: (i) a plurality of hierarchical functions, wherein each function comprises one or more elements, wherein each function represents part of the process or system, and wherein each element is reproducible in more than one function, and (ii) one or more sequence-indicating links between functions that indicate a flow between the functions comprising the process or system, wherein the processor is arranged to control a display device to display the model to the user, wherein the modeling system is arranged to store data indicative of the model on a storage device; and wherein the modeling system is arranged to generate and output a document based on the model.

### CROSS-REFERENCE TO RELATED APPLICATION

This application claims the benefit of priority under the Paris Convention to the Jul. 18, 2014, filing date of Australian Patent Application No. 2014902790, which was filed on Jul. 18, 2014, and is titled A MODELLING SYSTEM AND METHOD FOR MODELLING A PROCESS OR SYSTEM. The entire disclosure of Australian Patent Application No. 2014902790 is hereby incorporated by reference.

### TECHNICAL FIELD

The present invention is generally related to a system modeling tool and particularly, although not exclusively, related to a function-based system modeling tool.

### RELATED ART

Organizations typically invest in information & communication technology (ICT) with the expectation of gaining capabilities of effective information systems, which would extend or improve their ability to perform functions and interact (for example, by generating and sharing information) for any number of reasons. However, such organizations can experience wide variations between their expectations and the actual outcomes when relying on the current business process management and IT software design knowledge base and tools.

There exists a challenge for Information Technology and improvement projects in organizations to produce strategically aligned business processes and application systems with functions that are effective in dealing with business needs and requirements. These are often dynamic and demand context-dependent inter-relationships, which need to be addressed while at the same time, maintaining the integrity of their building blocks. Typically this requires the combined output of project managers, architects, business analyst, application developers, change managers, subject matter experts and many other stakeholders. However, as is often the case, each group of specialists use frameworks to produce deliverables which make sense from a particular perspective, but together, does not adequately address the crucial need for alignment and inter-relatedness, now and in the future.

There is therefore a need to invent a tool or device for organizations to reflect what the organization's business model is, how it works and how it can improve over time. There is a need to produce systems or processes that align with the business activities of the organization, so that its people, who are generally assigned different specialist roles, can then use such a system or process across a common environment between all of the specialist workers. Thus there is a requirement to enable a group of employees across an organization to model systems and processes for the organization in the same environment.

The present invention provides a function-based system modeling tool that enables users to organize the necessary breakdown of any kind of work performed by any type of organization, into components or functions. The functions thus created are connected by decision options and links which signify the flow or sequence of undertaking the functions and thereby representing processes.

### SUMMARY

In a first broad aspect, the invention provides a modeling system for modeling a process or system comprising:

a processor arranged to execute a user-interface module and to receive input commands from a user,

wherein the user-interface module facilitates the building of a model from the input commands, wherein the model includes: (i) a plurality of hierarchical functions, wherein each function comprises one or more elements, wherein each function represents part of the process or system, and wherein each element is reproducible in more than one function, and (ii) one or more sequence-indicating links between functions that indicate a flow between the functions comprising the process or system,

wherein the processor is arranged to control a display device to display the model to the user,

wherein the modeling system is arranged to store data indicative of the model on a storage device; and

wherein the modeling system is arranged to generate and output a document based on the model.

In an embodiment, the model includes one or more decision options.

In an embodiment, each function is a business function, an application function, or an information-based function.

In an embodiment, a business function comprises at least one action element and at least one participant element.

In an embodiment, a business function optionally comprises at least one data element or at least one resource element or both.

In an embodiment, an application function comprises at least one data element and at least one action element.

In an embodiment, an application function includes components comprising any combination of a user interface, an application interface, a data operation, and processing logic.

In an embodiment, an information-based function comprises at least one action element, at least one participant element, and at least one data element.

In an embodiment, an information-based function optionally comprises at least one resource element.

In an embodiment, the user-interface module facilitates six levels of granularity for business functions.

In an embodiment, the output is a software specification document, a specification for database design, a specification for an application system, or a process model document.

In an embodiment, one or more requirements or rules are defined at an application function, an application system or an application system module level.

In an embodiment, an application component comprises reusable application services.

In an embodiment, any one of said business function, said application function, or said information-based function has at least one sub-function which represents a subset of the respective function's capabilities.

In a second broad aspect the invention provides a modeling method for modeling a process or system comprising:

executing a user-interface module and receiving input commands from a user at a processor;

building at the user-interface module a model from the input commands, wherein the model includes: (i) a plurality of hierarchical functions, wherein each function comprises one or more elements, wherein each function represents part of the process or system, and wherein each element is reproducible in more than one function, and (ii) one or more sequence-indicating links between functions that indicate a flow between the functions comprising the process or system;

controlling a display device to display the model to the user;

storing data indicative of the model on a storage device; and

generating and outputting a document based on the model.

In an embodiment, the model includes one or more decision options.

In an embodiment, each function is a business function, an application function, or an information-based function.

In an embodiment, a business function comprises at least one action element and at least one participant element.

In an embodiment, a business function optionally comprises at least one data element or at least one resource element or both.

In an embodiment, an application function comprises at least one data element and at least one action element.

In an embodiment, an application function includes components comprising any combination of a user interface, an application interface, a data operation, and processing logic.

In an embodiment, an information-based function comprises at least one action element, at least one participant element, and at least one data element.

In an embodiment, an information-based function optionally comprises at least one resource element.

In an embodiment, the user-interface module facilitates six levels of granularity for business functions.

In an embodiment, the output is a software specification document, a specification for database design, a specification for an application system, or a process model document.

In an embodiment, one or more requirements or rules are defined at an application function, an application system or an application system module level.

In an embodiment, an application component comprises reusable application services.

It is to be noted that the “user interface module” refers to the UI of the modeling system or function-based system modeling tool, while “user interface” refers to the UI component of an application function.

In a third broad aspect the invention provides a computer program adapted to control a computing device to implement the method of the second broad aspect.

In a fourth broad aspect the invention provides a computer readable medium comprising a computer program of the third broad aspect.

### BRIEF DESCRIPTION OF THE DRAWINGS

In order that the invention may be more clearly ascertained, embodiments will now be described, by way of example, with reference to the accompanying drawing, in which:

FIG. 1 is a main user interface of the function-based system modeling tool of the invention;

FIG. 2 is the user interface of FIG. 1 showing a transaction screen;

FIG. 3 is the user interface of FIG. 1 showing an expanded administration menu;

FIG. 4 is the user interface of FIG. 1 showing a business action sub-item transaction screen;

FIG. 5 is the user interface of FIG. 1 showing a participant/user role transaction screen;

FIG. 6 is the user interface of FIG. 1 showing an expanded administration menu, building blocks sub-menu and data sub-menu;

FIG. 7 is the user interface of FIG. 1 showing a data concepts sub-menu item transaction screen;

FIG. 8 is the user interface of FIG. 1 showing a resources sub-menu item transaction screen and a resource-to-function associations transaction screen;

FIG. 9 is the user interface of FIG. 1 showing a decision option transaction screen;

FIG. 10 is the user interface of FIG. 1 showing an application function context menu;

FIG. 11 is the user interface of FIG. 1 showing a functional context and notes transaction screen;

FIG. 12 is the user interface of FIG. 1 showing a to-do list transaction screen;

FIG. 13 is the user interface of FIG. 10 also showing a maintain-application-components sub-menu;

FIG. 14a is the user interface of FIG. 1 showing an application-function user interface transaction screen;

FIG. 14b is the user interface of FIG. 1 showing another embodiment of an application-function user interface transaction screen;

FIG. 15a is the user interface of FIG. 1 showing an application-function interface transaction screen;

FIG. 15b is the user interface of FIG. 15a also showing an application-function interface data transaction screen;

FIG. 15c is a user interface similar to that of FIG. 15a and showing a different application-function interface data transaction screen compared to FIG. 15b;

FIG. 16 is the user interface of FIG. 1 showing an application function processing logic transaction screen;

FIG. 17 is the user interface of FIG. 1 showing an application function data operation transaction screen;

FIG. 18 is the user interface of FIG. 1 showing an expanded manage menu and an expanded application services sub-menu;

FIG. 19 is the user interface of FIG. 1 showing a data operation service screen; and

FIG. 20 is the user interface of FIG. 1 showing a business function context menu;

FIG. 21 is a framework diagram that shows the hierarchical relationship between items that can be defined or modeled by the function-based system modeling tool of the invention;

FIG. 22 is the user interface of FIG. 1 showing a business function granularity level transaction screen;

FIG. 23 is the user interface of FIG. 1 showing a maintain requirements and business rules transaction screen;

FIG. 24 is the user interface of FIG. 1 showing an information-based function context menu;

FIG. 25a is a user interface similar to FIG. 1 showing a maintain business process details transaction screen;

FIG. 25b is a user interface showing a view process map;

FIG. 26 is the user interface of FIG. 25a also showing a create process snapshot screen;

FIG. 27 is a user interface similar to FIG. 1 showing a select process snapshot form screen;

FIG. 28 is the user interface of FIG. 27 also showing a compare business process versions screen;

FIG. 29 is the user interface of FIG. 25a also showing a maintain user permissions screen;

FIG. 30 is the user interface of FIG. 1 showing an expanded application system sub-menu;

FIG. 31 is a user interface similar to FIG. 1 showing a maintain application system details transaction screen; and

FIG. 32 is the user interface of FIG. 31 showing a maintain application system module screen.

### DETAILED DESCRIPTION

The invention is generally related to a modeling system and method for modeling a process or system that can be used to represent, the breakdown and design of any suitable type of work performed by any suitable type of organization, such as work executed by business organizations, government institutions and associations. In particular, the function-based system and modeling tool enables the modeling of business-IT aligned systems/processes, while supporting Service Oriented Architecture.

The function-based system modeling tool provides a drawing surface, on which a user can build, maintain or manage a model of a process. The modeling system may be provided by a user-interface module, which may be, for example, software running on or executed by a processor. A model is displayed to a user on a display device, such as a monitor. The processor is typically arranged to control the display device to display a model and other UI elements to the user. Data indicative of the model and other UI elements may be stored on a server or other storage device. The processor is arranged to receive input commands from the user and to pass them to the user-interface module for facilitating the building or creating of a model. In this specification, an example model is given that models a process for enrolling a student into a course, such as at a tertiary-education institution. A user will typically be a person who has knowledge of the business service or processes being modeled, such as a business analyst or systems architect.

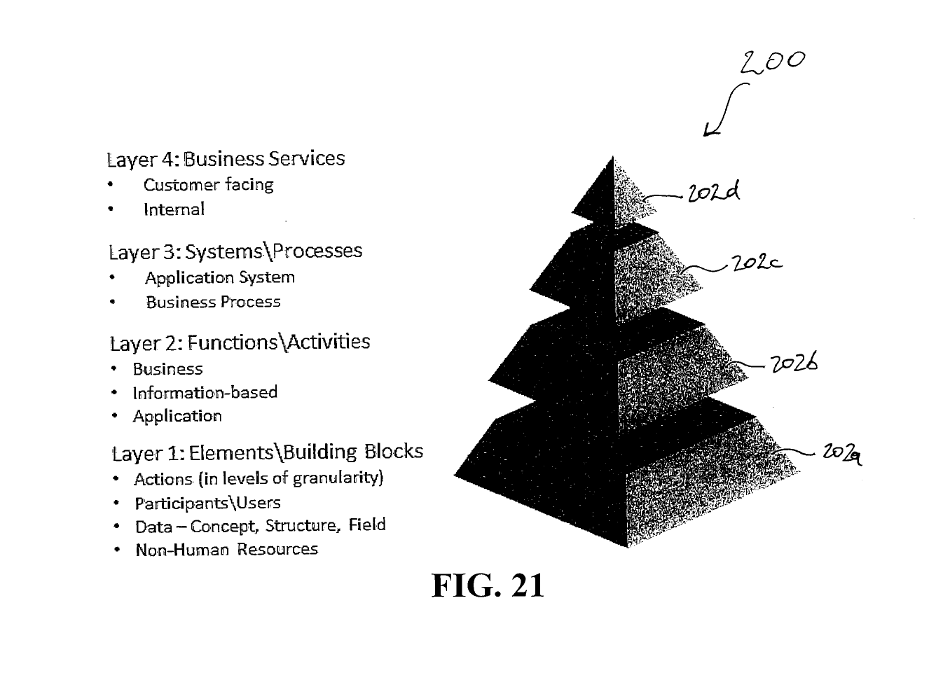

FIG. 21 illustrates a framework 200 that is representative of the function-based system modeling tool. The framework comprises four layers 202: (i) an element/building block layer 202a, (ii) a functions/activities layer 202b, (iii) a systems/processes layer 202c, and (iv) an organization/business services layer 202d.

The organization/business services layer 202d represents an organized collection of processes that define how an organization creates products or provides services (or both) that may ultimately be consumed or used internally by other members of the organization, or externally by customers and other interested parties. For example, a university may offer students an enrolment service.

Reverting to the bottom layer of the framework 200, the element/building block layer 202a represents the irreducible items that are used to create the functional components of a process or system 202c (such as in the functions/activities layer 202b). The function-based system modeling tool may provide any suitable element. In an embodiment, the function-based system modeling tool provides four types of elements: (i) actions, (ii) participants/users, (iii) data, and (iv) non-human resources.

An action may be considered to represent the main purpose of a function. In other words, an action describes what the function or activity intends to achieve. Actions are typically defined at varying levels of granularity and preciseness, and usually encapsulate rules (such as company policies, procedures and rules). A participant may refer to who is involved in performing a function. A participant may be an individual, a group, an organization, a machine, or any other suitable participant. Each participant has an assigned role. Further, a participant user may refer to a participant when they are using an application function (described below). Note that in such situations, the participant user is generally not involved in the performance of the application function, but may use the application function to perform a business function or information-based function (which are also described below) that they are involved in.

Data may refer to any symbol, character (e.g. alphabetic, numeric and special characters), icon, picture, or any other suitable token that is used to create information about objects and phenomena of interest. Data can be further sub-divided into: (i) data concepts, (ii) data structures, and (iii) data fields. A data concept may refer to common or ‘headline’ terms generally used to represent or describe information about an object or phenomenon (or some aspect of it) that is of interest. Each data concept comprises one or more fields. A data structure may refer to a logically organized set of fields (for example, entity, record, file, etc.) and relationships (for example, entity relationships). Each data structure comprises one or more data fields. A data field may refer to an identifier or descriptor of a data concept or structure.

Finally, a resource may refer to assets (such as plant, tools and equipment) and materials that are used as part of performing a function.

A component is a general term that may refer to any suitable sub-division of the ‘whole’ (i.e. process or system) that provides specific functions that contribute to fulfilling the intentional purposes of the same ‘whole’, hence functional components. Each component comprises one or more elements as described above, and an element may belong to one or more components.

The functions/activities layer 202b may represent the ongoing ‘working together’ of the chosen elements in a given component to fulfil or contribute to fulfilling the intentional purposes of the process or system. The function-based system modeling tool may provide any suitable function. In an embodiment, the function-based system modeling tool provides three types of functions: (i) business functions, (ii) information-based functions, and (iii) application functions. Business function components may be created in multiple levels of granularity. In an embodiment, business function components can be created in up to six levels of granularity.

A business function may refer to a functional component whose elements include actions and participants, and optionally includes data and resources. A business function may be used to represent a high-level function that requires further breakdown or a manual function. An information-based function may represent a functional component whose elements include actions, participants, data, and optionally, resources. An information-based function may be considered as a special type of business function whose main purpose is to generate, manipulate, or exchange information (or any combination thereof). An application function may refer to a function whose elements only include data and actions (and their associated rules). This function is typically implemented as software, and used by participant users (for example, individuals only) to perform other functions in which they are involved.

The systems/processes layer 202c represents the application systems and business processes that make up the organization/business services 202d. An application system is any integrated ‘whole’ that comprises components (discussed below) that work purposefully together. A system can represent inter-relationships between such components so that the variety and subjectivity inherent in the dynamics can be organized and managed. An application system may be defined as a system comprising components that are only application functions. An application system module may refer to any sub-division of an application system.

A process may refer to an organized collection of functions (i.e. business functions, information-based functions and application functions) linked together to indicate a flow or the sequence in which they are performed to achieve an intended purpose. A process may also be considered as a system because its components also work together purposefully. A process may comprise all three types of functions, or any suitable combination thereof.

The function-based system modeling tool allows a user to create and maintain a list of element values that define each component function, thereby contributing to a model of a process or system. Such component functions can be created graphically on a user interface for the systems/processes layer 202c while maintaining their constituent elements. Application services can be created, maintained and reused when specifying an application function component.

The modeling system or function-based system modeling tool may allow a user to create a business function at any suitable level of granularity provided by the system or tool. For example, the business function may provide six levels of granularity, though any suitable number of levels may be provided. The user may also create an application function, which typically provides only one level of granularity. The user may also create an information-based function, which typically provides only one level of granularity. An application function comprises one or more components, where these components may specify the application function's required user interfaces, application interfaces, data operations and processing logic.

A business process is typically represented or modeled by a plurality of functions (such as business functions, information-based functions and application functions) linked together to indicate a flow or sequence in which the functions are performed. Each participating function may have appropriately named sub-functions which represent a sub-set of the function's capabilities that are relevant steps in the Business Process. Customer-facing or internal organization services can be created from processes that are modeled using any suitable combination of application functions, information-based functions and business functions.

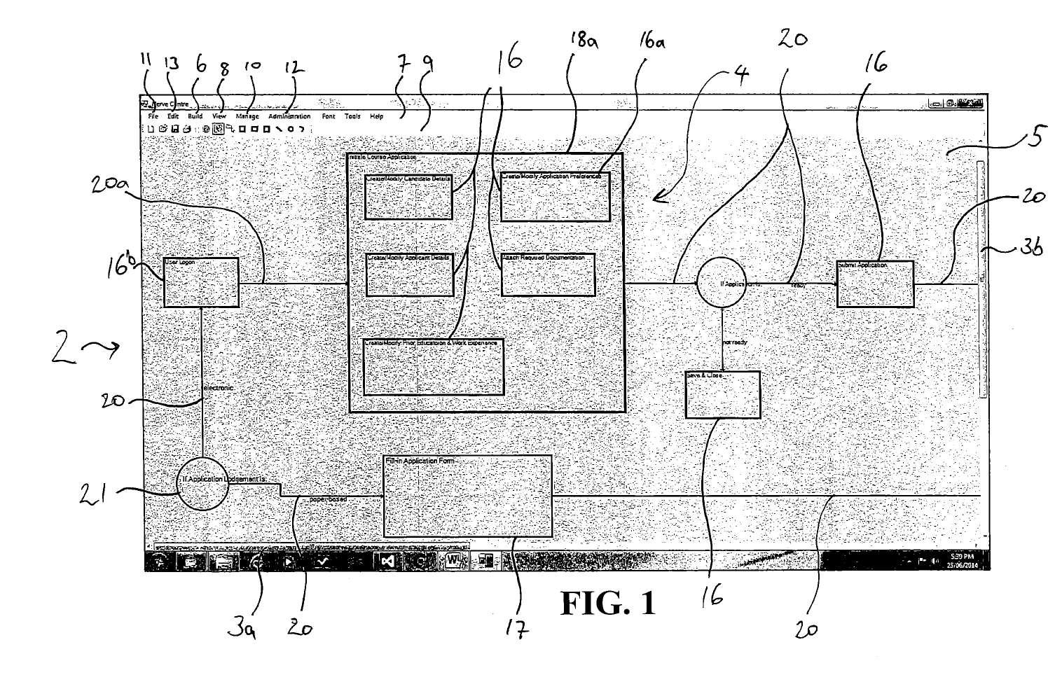

FIG. 1 illustrates a UI 2 where a user has designed or built a model 4 of a process or system, for example, for the enrolling process (though only part of the model 4 is shown). The UI 2 may provide a horizontal scroll bar 3a and a vertical scroll bar 3b for respective horizontal and vertical scrolling (to reveal other parts of the model) and allow the user to zoom in and out. The UI 2 provides a canvas or drawing surface 5 on which the user can draw or design a model 4. The UI 2 may provide a menu bar 7 with a file menu 11, an edit menu 13, a build menu 6, a view menu 8, a manage menu 10 and an administration menu 12. However, any other suitable menus, such as font, tools and help, may be provided. The UI 2 may also provide a tool bar 9 with a number of buttons that allow a user to inter alia open, save, print or build a model 4 (though such functionality may also be available through the menus on the menu bar 7). The model 4 can be saved to a file in any suitable manner and loaded again at a later time. In an embodiment, the main UI 2 typically provides at least a file menu 11, a build menu 6, a view menu 8, a manage menu 10 and an administration menu 12, each of which comprises any suitable combination of items and sub-menus, as is discussed further below. The menus 6,8,10,11,12,13 may be pull-down menus or any other suitable type of menu.

Upon selecting the build menu 6 (for example with an input device such as a mouse or keyboard), the UI 2 displays a number of associated items or sub-menus. In an embodiment, the build menu 6 may provide an application item, a business item, a decision item and a link item. Upon selecting such an item, the user may be allowed to draw or create a corresponding shape as a part of the model 4. It is noted that in this specification the term “shape” and related terms such as “shapes” refers to all parts of the model, such as rectangles, circles, lines and connector points.

Elements of the model 4 may be represented by any suitable shape with any suitable characteristics, but typically similar elements (such as all of the business functions in a model 4) are represented by shapes with the same or similar characteristics (for example, color, line thickness). For example, the application functions 16 in a model 4 may be represented by black rectangles, the information-based functions 17 may be represented by blue rectangles, the business functions 18 may be represented by green rectangles, the decision options 21 may be represented by black circles, and connector lines or sequence-indicating links 20 may be represented by black lines.

The model 4 graphically depicts the application 16, information-based 17 and business 18 functions according to a hierarchy of function relationships, where such a hierarchy is defined by the user. Business function 18a and the functions therein depict a two-level hierarchy. In an embodiment, the function-based system modeling tool allows for granularity levels of up to six, though any suitable number of hierarchy levels may be provided.

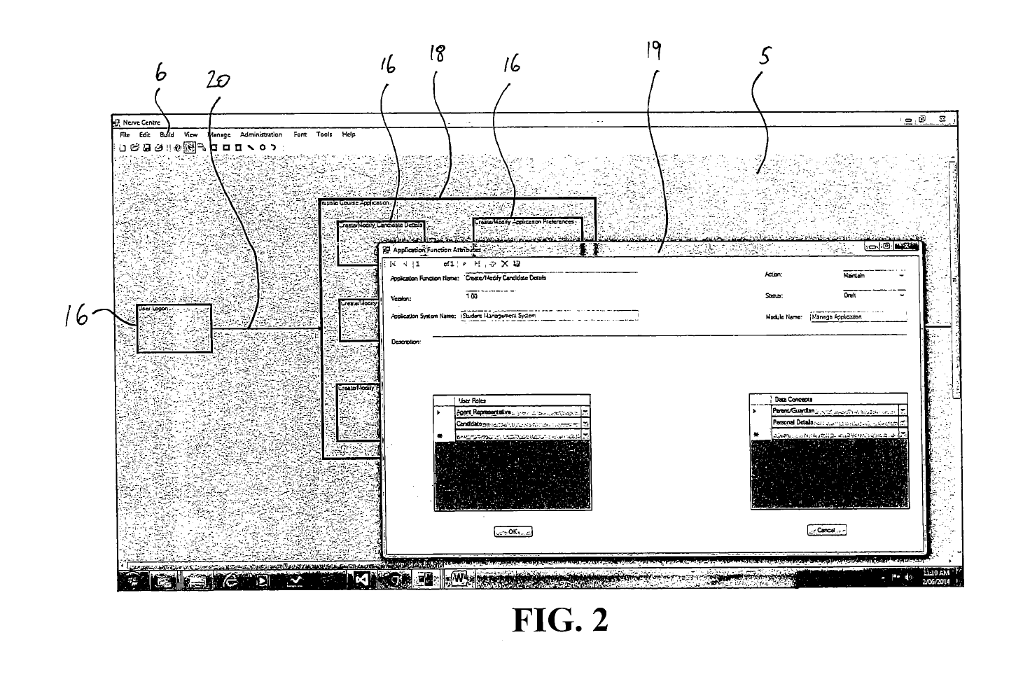

Referring to FIG. 2, upon selecting the application item, the modeling system may allow a user to draw an application function 16 on the drawing surface 5 of the UI 2. Upon completion of the drawing, the UI 2 may present a transaction screen 19 that allows the user to specify certain elements and characteristics or attributes of the application function 16, as is discussed below. Other functions such as business functions 18, decision options 21 (not shown in FIG. 2) and links 20 may similarly be created from the build menu 6.

An application function 16 may have any suitable element that can be selected, and attributes that can either be selected or set by the user. For example, in the enrolling process model, an application function 16 may have a number of elements such as action, participant user roles, and data concepts that can be selected by the user (for example, from a predefined list), and attributes such as: (i) application function name, (ii) version, (iii) status, and (iv) description that can be selected or set by the user. Some attributes (such as application function name) may have only one field value, whereas other attributes (such as participant user roles) may have multiple field values that may be limited to a selection of one or more entries from a pre-defined list. The participant user roles attribute may indicate which parties use a particular application function 16. Referring to FIG. 1, in the enrolling process example, there may be a “create/modify application preferences” application function 16a that is part of a higher-level “initiate course application” business function 18a. The participant user roles attribute in such an application function 16a may include parties who interact with data handled by the application function 16a, such as the candidate (who creates the application details) and a secretary (who sends interview letters using those details to potential course candidates). Data concepts and any other suitable attribute may be similarly executed. A similar transaction screen may be available for business and information-based functions.

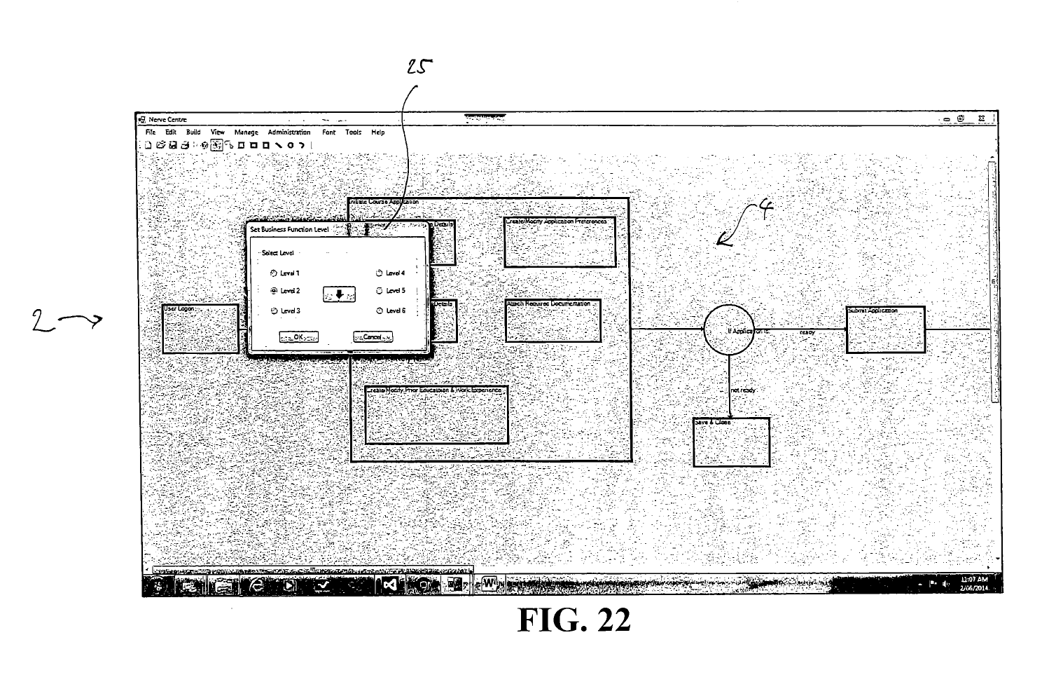

Referring to FIG. 22, a user may be able to set the granularity level of a business function by controlling the UI 2 to display a business function granularity level transaction screen 25, choosing a granularity level, and clicking “ok”. In an embodiment, 6 levels of granularity are available, though a different number of levels may be provided in other embodiments. Importantly, the model 4 shows and models a hierarchy (or relationship based structure) between functions. The granularity of the business functions is unrelated to this hierarchy, but should rather be considered a level of action preciseness. For example, a first business function may have a granularity of 1, and a second business function may have a granularity of 3. The user may embed the second in the first, thereby defining a hierarchy, where the functions each have a granularity. Typically, application functions and information-based functions only have one level of granularity.

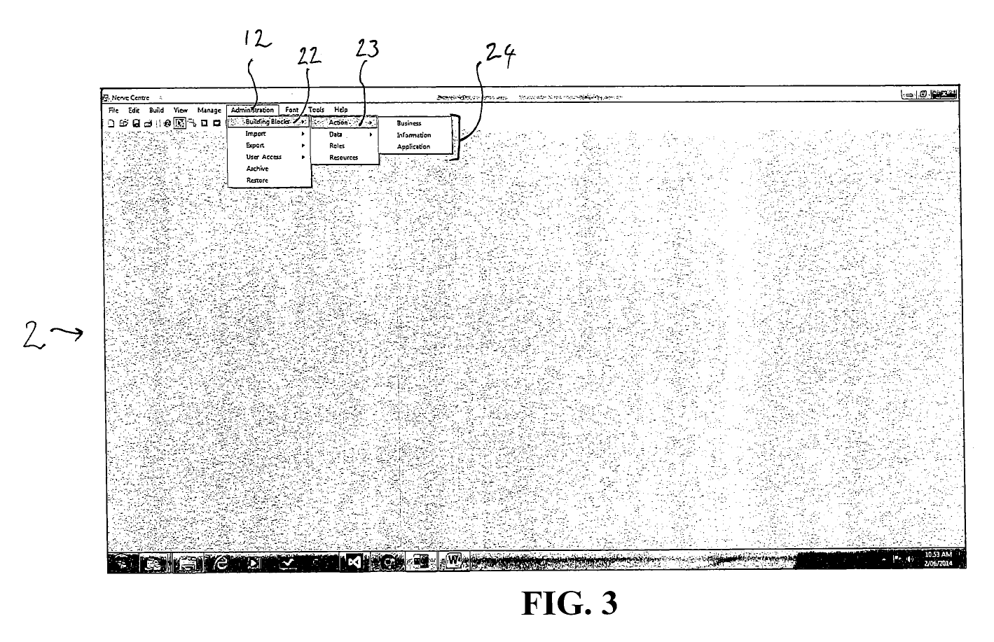

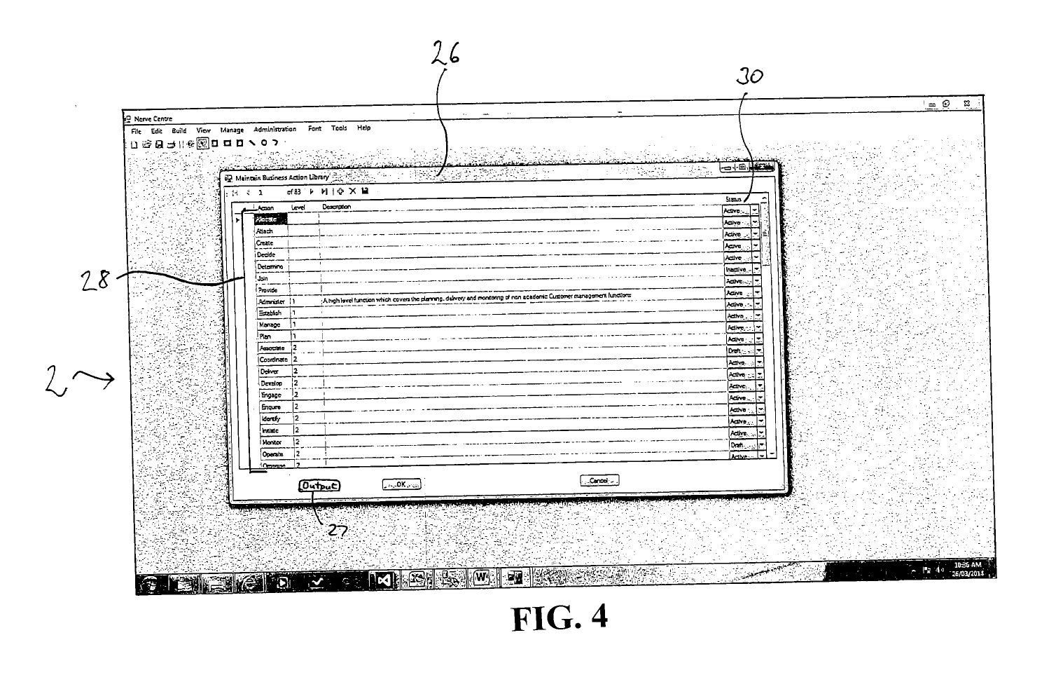

FIGS. 3 to 5 illustrate the predefining or setting up of closed-ended element\building block attributes, such as the participant roles as may be attributed to application, information-based or business functions. In particular, FIG. 3 illustrates a UI 2 where a user has clicked on the administration menu 12 in order to reveal a building blocks sub-menu 22 and an action sub-sub-menu 23 that comprises application, information and business items 24. Referring to FIG. 4, upon selecting, for example, the business item, the UI 2 displays a business action sub-item transaction screen 26 called “Maintain Business Action Library”. (A similar transaction screen may be available for the application and information-based action items.) The business action sub-item transaction screen 26 comprises a list of selectable actions 28, which may be predefined, user definable, or both. Each action 28 may have an associated status 30, which can be set to active, inactive, draft or any other suitable status. Only actions with an ‘active’ status are made available when creating or updating a function. An authorized user can create, update and/or delete actions 28 on screen 26 as well as export all or a selection of actions to Microsoft Word by clicking on Output button 27 using a conversion tool. Equally the actions 28 can be exported to another format such as Microsoft Excel or as a PDF. This can also be done on transaction screens for the application and information-based action items.

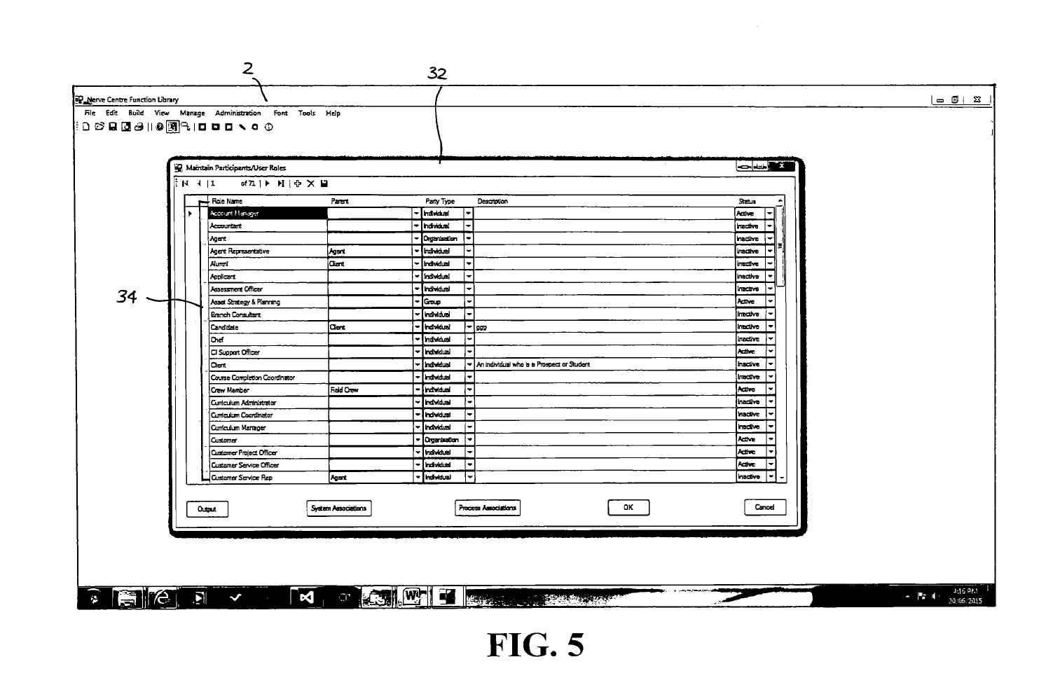

Referring to FIG. 5, the UI 2 displays a participant/user role transaction screen 32, called “Maintain Participants/Users Roles”, upon selecting the roles menu item from the sub-menu 22. The participant/user role transaction screen 32 comprises a list of available attributes 34 for the selected participant or user, and may have an associated role name, parent, party type, description and status. The attributes 34 may be predefined, user definable, or both. These attributes 34 become available when setting application or business function attributes, as shown in FIG. 2.

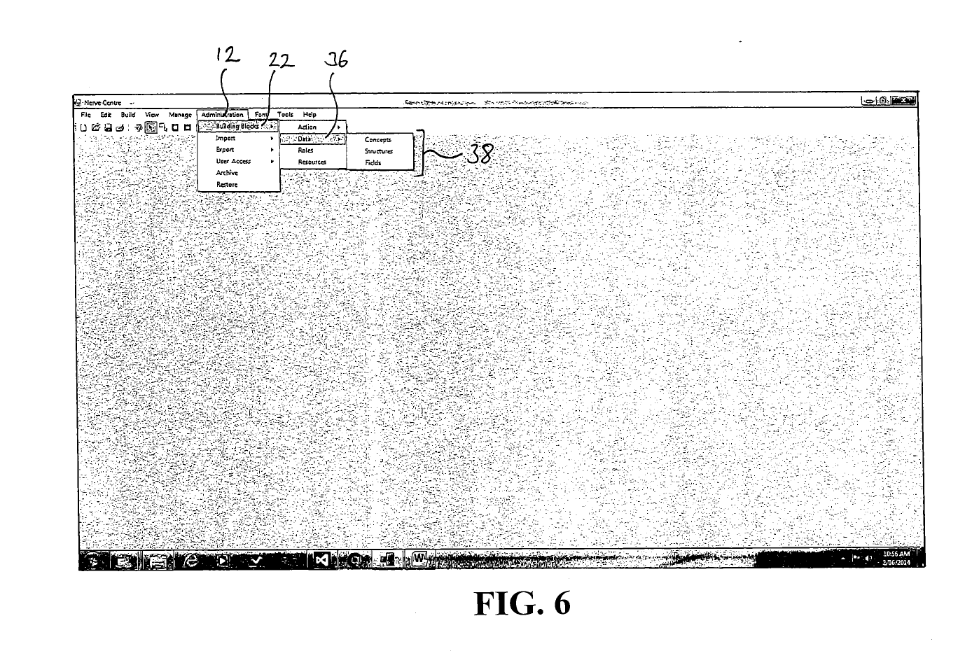

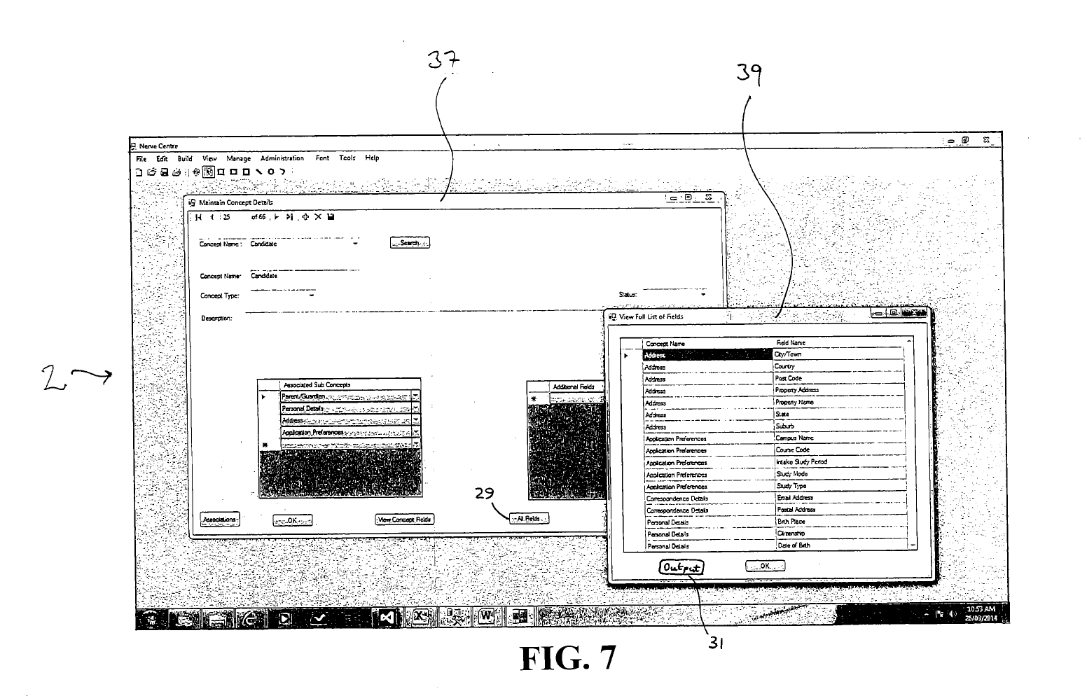

Referring to FIG. 6, the administration menu 12 may similarly provide a building blocks sub-menu 22 and a data sub-sub-menu 36 that comprises concepts, structures and fields items 38. The UI 2 may display a data concepts sub-item transaction screen 37 (FIG. 7) upon selection of the concepts item, which allows a user to edit concepts, structures and fields. Data fields define all of the data available to or required by the model, and each data field is indivisible. For example, when applying to enroll in a course, a student may have many associated data fields, such as: (i) name, (ii) age, (iii) gender, (iv) previous school, (v) completion year at previous school, and so on. Data concepts comprise one or more data fields, and are generally used to represent or describe information about an object, phenomenon, or some aspect of the model that is of interest. Data fields can be logically organized into data structures, which may, for example, define an entity relationship diagram. Continuing the above example, a “student” data concept may require a name, age, gender, previous school and completion year data fields. However, a “personal details” data structure may be defined as the name, gender and age data fields. A second “education background” data structure may be defined as the previous school and completion year data fields. Each data field may form part of one or more data concepts as well as data structures. An authorized user is able to assign one or more fields to particular data concepts and/or data structures by clicking an “Assign” button. In addition the user is able to export all, or a selection of data fields to Microsoft Word, by clicking on an ‘Output’ button.

Referring to FIG. 7, the UI 2 may display a data concepts sub-menu item transaction screen 37 upon the user selecting the concepts sub-menu item. Data concepts can be created, updated or deleted from the data concepts sub-menu item transaction screen 37. For example, the user may create a data concept called “address” that defines the student's address from a plurality of data fields. The relevant data fields may include city/town, country, postcode, property address, property name, state and suburb. A single data field could be used in more than one data concept. For example, a student's country data field may be relevant to their address and their correspondence details. The UI 2 may also be controlled to display a data concept-to-field associations transaction screen 39 by clicking on the All Fields button 29 that shows a list of created data concepts and their associated fields. Any related data structures and/or the field name in the data structure can also be shown in screen 39. It may be possible to define a data concept by using other data concepts (i.e. all of the sub-concepts' associated data fields) as well as other data fields. On screen 39, the user is able to export all, or a selection of associations to Microsoft Word, by clicking on the ‘Output’ button 31. The user only needs to enter the Data Concept Name and Description. The status for each Data Concept can be set to ‘Draft’, ‘Active’ or ‘Inactive’. Only Data Concepts with a Status of ‘Active’ are made available when creating or updating a function.

A particular data concept can be defined in a similar manner to the attributes described above. Each data concept may comprise: (i) a concept name, (ii) a concept type, (iii) one or more associated sub concepts, (iv) one or more fields, (v) a description, and (vi) a status. The data concepts provide a pre-defined list that a user can choose from when creating, updating or maintaining an application, information-based or business function.

An authorized User is thus able to create, update or delete data concepts and/or the associated sub-concepts and fields on this screen. The user is able to select a particular data concept to maintain, by selecting the value and clicking a ‘Select’ button, or using Move icons in the toolbar.

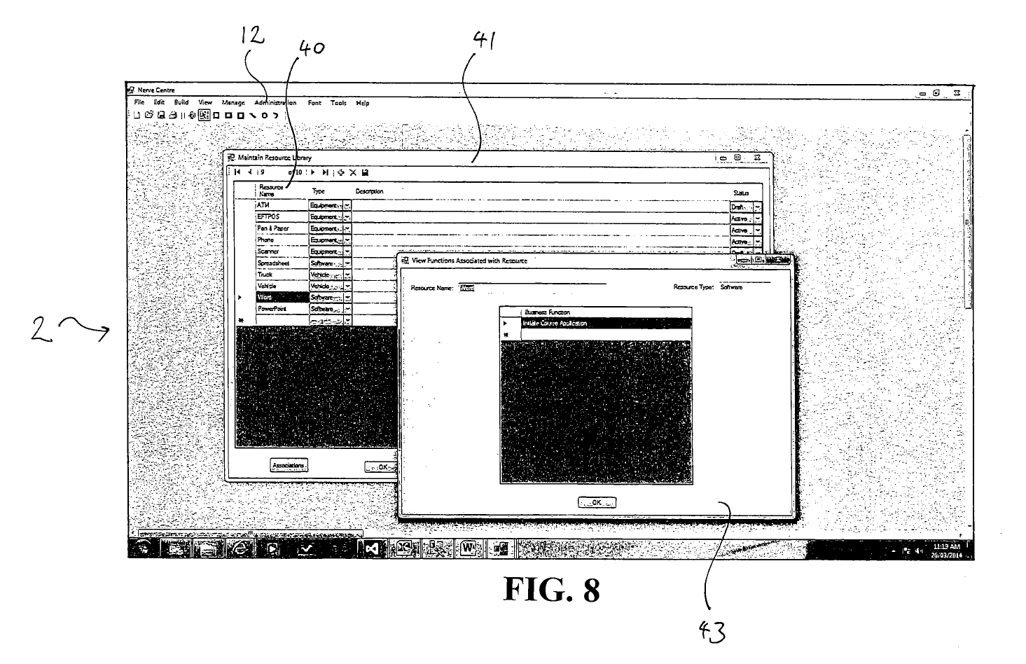

Referring to FIG. 8, the UI 2 may similarly allow a user to define a list of non-human resources 40 (such as a scanner or vehicle), each with an associated type (e.g. equipment, vehicle or software), description and status, that may be used when creating, updating or maintaining a business function or information-based function. A user may define the non-human resources 40 via a resources sub-menu item transaction screen 41 accessed, for example, through the administration menu 12 and the building blocks sub menu 22. The resources sub-menu item transaction screen 41 may allow for a user to create, update and delete resources as necessary. The user only needs to enter the resource name and description. The status for each resource can be set to ‘Draft’, ‘Active’ or ‘Inactive’. Only resources with a status of ‘Active’ are made available when creating or updating a business or information-based function. In addition the user is able to export all, or a selection of resources to Microsoft Word, by clicking on an ‘Output’ button. An authorized user is able to view a resource's function associations by clicking an “Associations” button.

Further, a user may select a particular resource and be presented with a resource-to-function associations transaction screen 43 that displays all of the functions that particular resource is associated with. This may be useful for planning or project management. The modeling system may generate such information by accessing a database that stores data or information about each aspect of the model.

Referring again to FIG. 1, the UI 2 may allow the user to build a model 4 of a business service, system or process using any suitable combination of application functions 16, information-based function 17, business functions 18, decision options 21 and links 20. As described above, the user may select a desired menu item or icon from the toolbar or from the build menu 6 and draw a corresponding shape onto the model 4, or create a respective shape in any other suitable manner. The user may define the attributes of each shape anteriorly or subsequently to drawing or placing it in the model 4 (as shown in FIG. 2). A typical model 4 may have application functions 16 and business functions 18 that are defined in a parent/child hierarchical relationship to one another, which is typically indicated by one function (the child) being contained by another function (the parent). For example, the “create/modify application preferences” application function 16a is a child of the “initiate course application” business function 18a. Further the hierarchy can go beyond parent/child. In an embodiment, business 18 functions can have a granularity of up to six levels, although other embodiments may provide for an even higher granularity. The function-based system modeling tool or UI 2 may determine the relationships between various shapes by calculating the size and location of each, and using the same to determine which shapes contains other shapes. However, the relationships between the shapes may be determined in any suitable manner. This determination affects how the completed model 4 will work.

FIG. 1 shows a partial model 4 for enrolling a student in a course. The model 4 may initiate at a “user logon” application function 16b that represents a customer (or in this case, a student) beginning an enrolment process. The application function 16b may have the following attributes: (i) a single participant being set to student, because the student is the only party involved with this step, and (ii) multiple data concepts comprising customer details and admission criteria. The admission criteria data concept may comprise additional fields such as attainment year and highest level of education.

The “user logon” application function 16b may link 20a to “initiate course application” business function 18a, which contains the “create/modify application preferences” application function 16a, and other application functions. Each of the afore-mentioned functions also has suitable attributes that are set by the user. For example, business function 18a may have a student participant attribute and also a curriculum coordinator participant attribute, because a curriculum coordinator may become involved at this point. The “initiate course application” business function 18a may represent an online enrolment process, in which a student navigates to an education institution website and provides personal details such as their name, address, gender, highest level of education, course applying for, and so forth. Further business functions 18 may represent information presented to the student upon submitting the application to enroll.

It should be noted that a business process (i.e. as modeled by a model 4 or part of a model) can comprise multiple application functions 16. However, a particular application function 16 can only be a part of one application system. Take, for example, an application system that models an accounting software package. Such an application system may have multiple application functions 16, such as an application function directed to accounts receivable and an application function directed to accounts payable. The accounting software can only have one function that processes accounts receivable because there may be inconsistent and conflicting data processing if another application function was to process accounts receivable. In contrast, a particular business function may be provided across two or more modeled business processes.

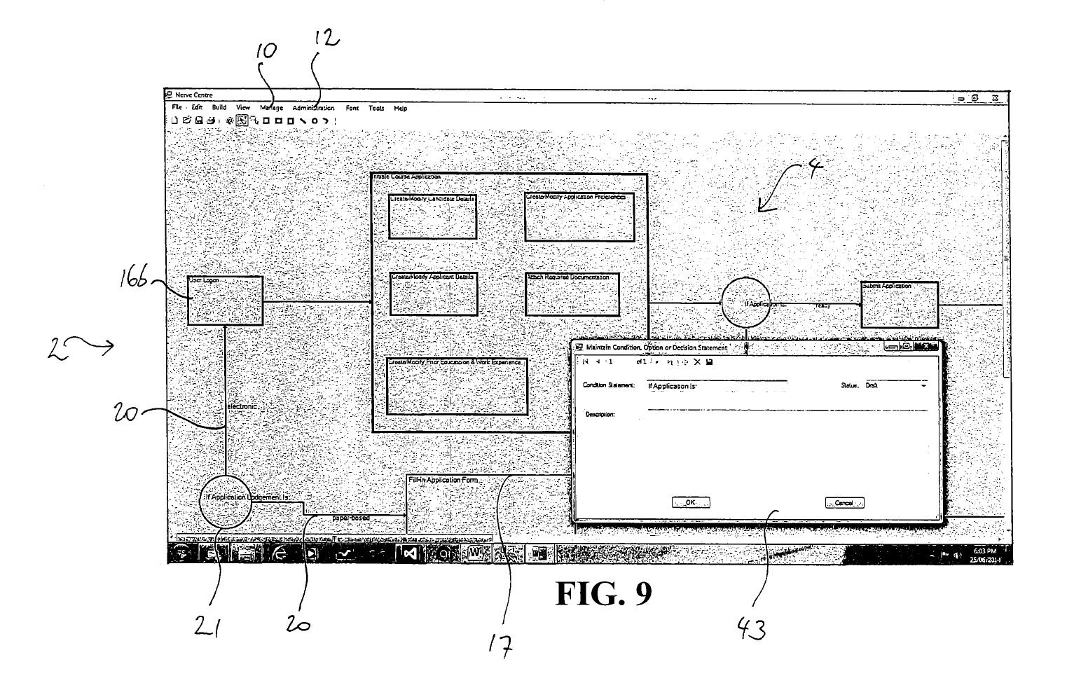

Referring to FIG. 9, the model 4 may include one or more decision options 21 for modeling different options or paths in a business process. For example, a student may be able to apply for a course electronically (e.g. online) or may be able to lodge a paper-based application. However, the student would not generally use both methods, and thus a decision option 21 is required. A decision option 21 typically implements a decision construct, such as an if statement, an if-else statement, a switch statement, or any other suitable construct.

A user may introduce a decision option 21 into a model by, for example, selecting a decision option from the build menu 6, and drawing a decision option 21 of a desired size or shape or both (similar to creating a function as described above). Typically, a decision option 21 is represented by a circle, but a decision option 21 may be represented by any suitable shape with any suitable attributes. A decision option 21 can be used to define alternative paths through the modeled process depending on a condition or event.

Referring to FIG. 9, the user of the function-based system modeling tool may be able to configure a decision option 21 in a similar manner to configuration of a function, such as a business function 18. In particular, the user may control the UI 2 to display a decision option transaction screen 43 associated with the decision option 21 by, for example, right clicking on the decision option 21 and selecting a “maintain decision option” option from a resulting menu. The decision option transaction screen 43 may allow the user to set a condition statement and define paths through the model 4 depending on the outcome of the condition statement. The decision option 21 may define two or more alternate paths, and typically each path has a corresponding outcome from the condition statement.

The decision option transaction screen 43 typically provides a condition statement field, with which the user can define the operation of the decision option 21. Decision option 21 is linked 20 to both the “user logon” application function 16b and the “fill in application form” information-based function 17, indicating that different paths can be taken through the model 4.

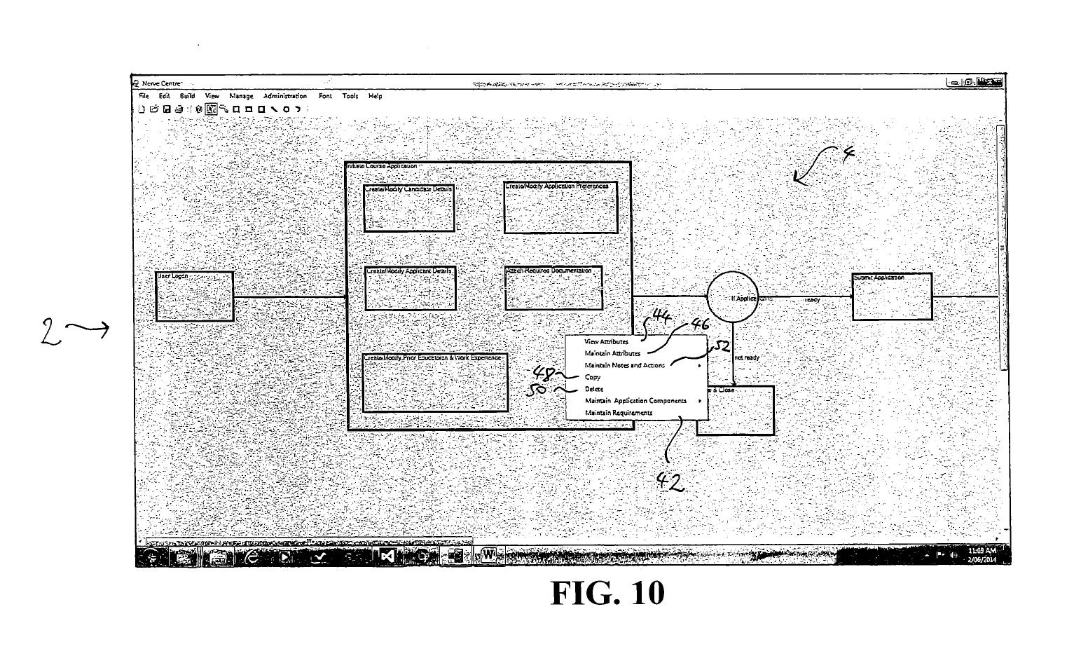

Referring to FIG. 10, the UI 2 may allow the user to view shape attributes, or maintain or modify elements in the model 4 directly from the model 4 itself. For example, the UI 2 may display to the user a context menu 42 upon right clicking on a shape of the model, though this may be done in any suitable manner. For example, right clicking on an application function 16 may cause the UI 2 to display a context menu 42 comprising any suitable items or sub-menus. The context menu 42 may display a view attributes item 44 that, upon selection, causes the UI 2 to display a window that lists the attributes for the application function 16 in question. The context menu 42 may display a maintain attributes item 46 that, upon selection, causes the UI 2 to display a transaction screen that allows the user to modify or edit the attributes of the application function 16 in question. The context menu 42 may display a copy item 48 that, upon selection, copies the application function 16 to a clipboard so that it may be replicated with a paste function elsewhere in the model 4. The context menu 42 may display a delete item 50 that, upon selection, deletes the application function. Deletion may include deletion of the shape from the model 4, deletion of attributes and deletion of relationships to other shapes including the deletion of any associated links 20.

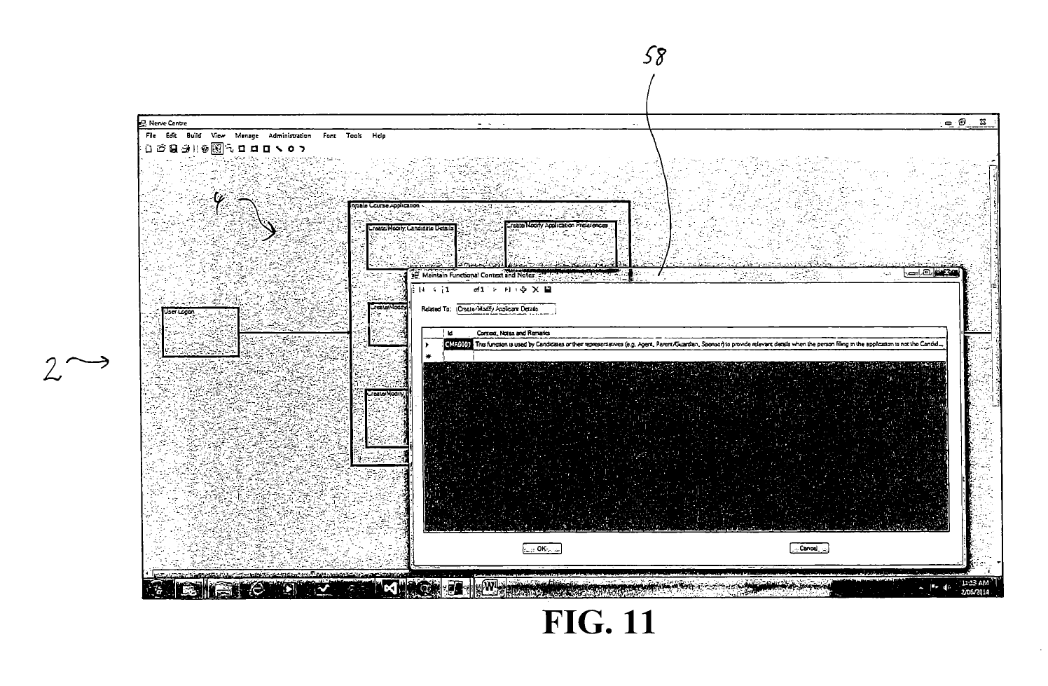

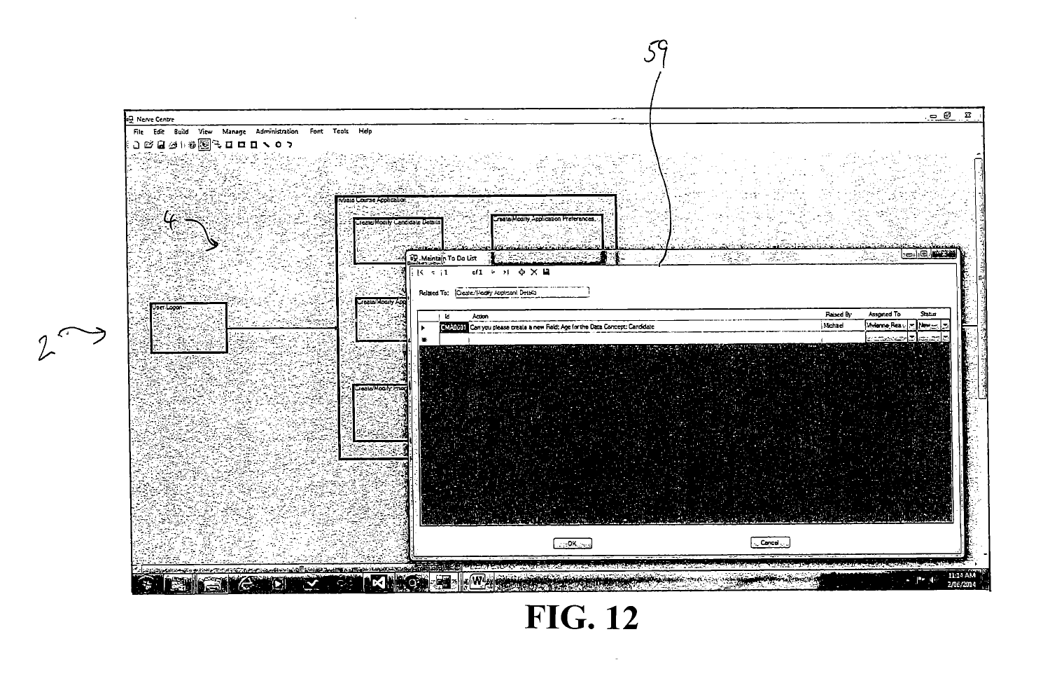

Referring to FIGS. 10 to 12, the context menu 42 may display a maintain notes and actions sub-menu 52 that comprises a notes item and a to-do list item. Selecting the notes item may cause the UI 2 to display a functional context and notes transaction screen 58, in which the user can enter or edit one or more notes or remarks, each of which has an associated identification marker, as is illustrated in FIG. 11. In an embodiment, the notes or remarks may be viewed or modified by other users who work on the model 4. Similarly, selecting the to-do list item may cause the UI 2 to display a to-do list transaction screen 59, in which the user can enter or edit one or more to-do entries, each of which has an associated identification marker, required action, indication as to who raised the item, indication as to who the item is assigned to, and status as is illustrated in FIG. 12. In an embodiment, the to-do actions may be viewed or modified by other users who work on the model 4. A user may receive a notification, such as an email, when an item is assigned to them. Such notifications may be selected or set via a “to do actions” transaction screen.

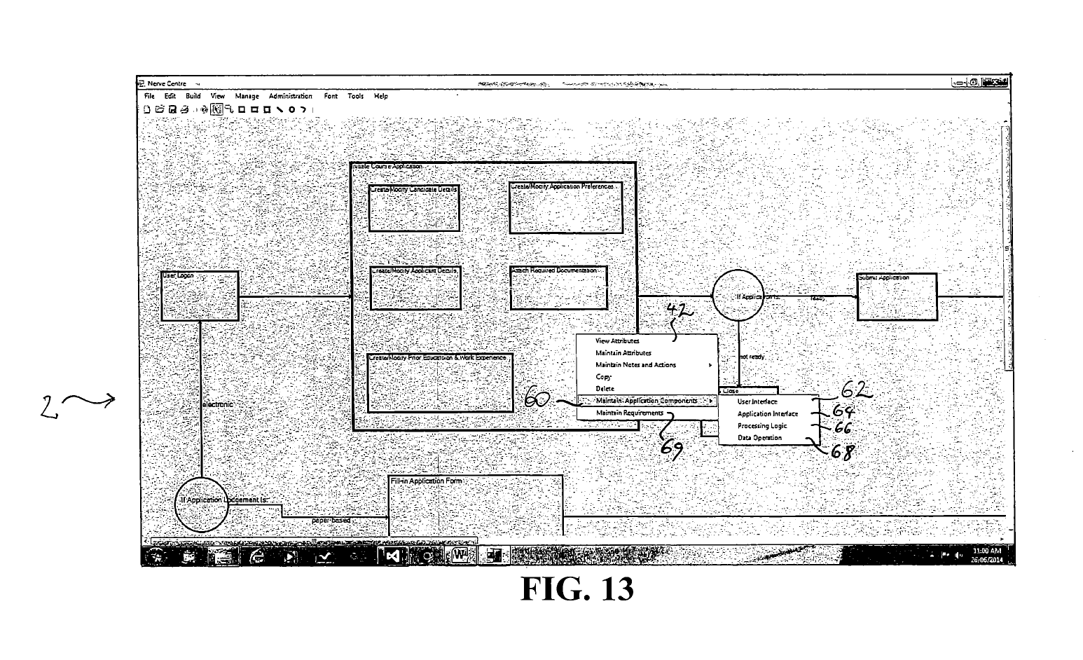

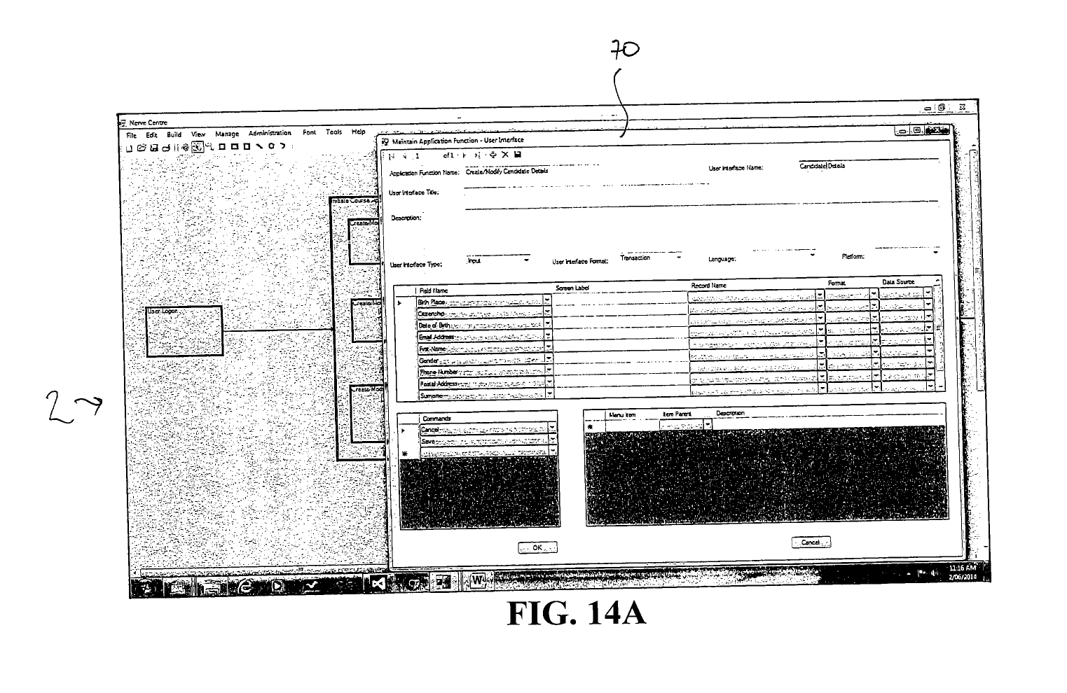

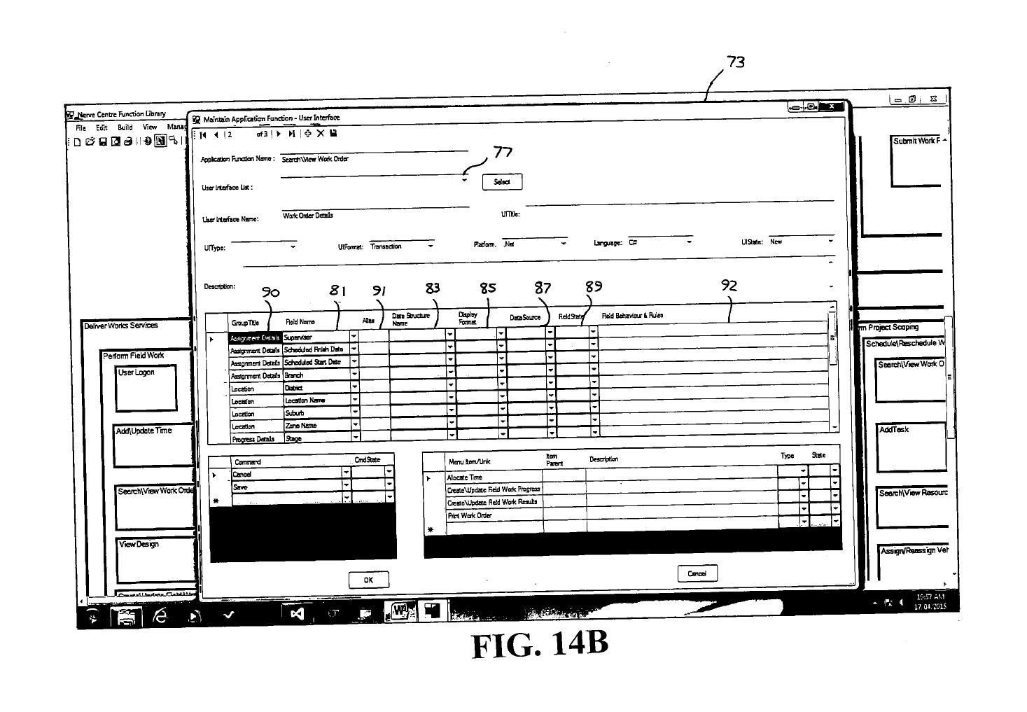

Referring to FIGS. 10, 13, 14a, 14b and 23, the context menu 42 for an application function may display a maintain application components sub-menu 60 that comprises: (i) a user interface item 62, (ii) an application interface item 64, (iii) a processing logic item 66, and (iv) a data operation item 68. Selecting the user interface item 62 may cause the UI 2 to display a user interface transaction screen 70, in which the user can edit one or more of the associated fields or attributes, as is illustrated in FIG. 14a. For example, the user may be able to define a number of attributes related to how the application function will appear to a participant user. FIG. 14a illustrates a user editing the attributes of a “create/modify candidate details” application function. In particular, the user has specified that the user interface of the “create/modify candidate details” application function includes several data fields such as “birth place”, “citizenship”, “date of birth” and so on. These fields will be presented to an end user (such as a student) for completion while performing the modeled process. Each data field may comprise an associated format and data source field.

An alternative user interface transaction screen 73 is shown in FIG. 14b. The user can either select a pre-defined User Interface Service from a User Interface List in drop-down box 77, or create a new one, by selecting and/or filling in the attribute values, then save by clicking the “OK” button. When a new User Interface is created, it is also added to the User Interface Service library so that it can be shared with other users. For each selected field, for example “Supervisor” 81, the user can choose the corresponding:

Data Structure 83 that the field belongs to;

Display Format 85 that defines how the field values are displayed (e.g. Text, Check Box, Combo Box, Date etc.);

Data Source 87 that defines who or what provides the field values (e.g. User, API, System etc.);

Current State 89 that represent the field status in relation to the User Interface (e.g. New, Active, Change, Remove etc.).

In addition the user can, as required, enter:

Group Title 90 that defines which related Fields are displayed together;

Alias 91 that defines the Field Name label that is displayed;

Field Behavior and Rules 92 that defines user access and field maintenance rules.

If a pre-defined User Interface Service is selected, it checks to make sure that all the fields are available from the associated Application Function's defined Data Concepts. Also, the user is able to select the commands that appear on the User Interface screen. If the User Interface includes Menu Items or Links to other functions, once again, the user is able to select/enter the required details. Each application function may have zero, one or more User Interface screens.

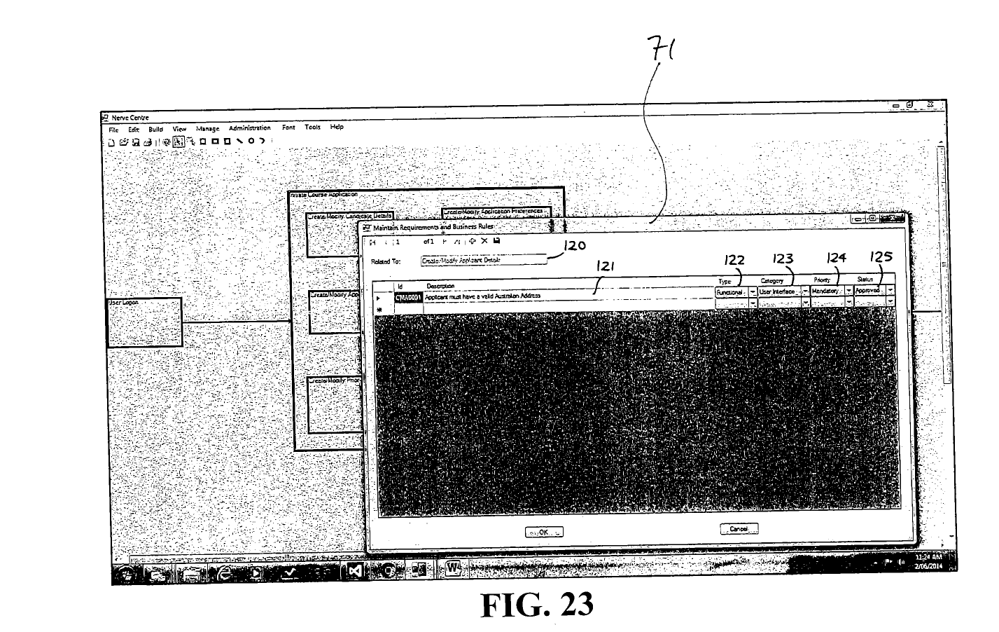

The application function context menu 42 may also comprise a maintain requirements item 69, which, when clicked on, opens a maintain requirements and business rules transaction screen 71, shown in FIG. 23. The maintain requirements and business rules transaction screen 71 allows a user to define or fill in attributes associated with the particular application function. For example, in a “create/modify applicant details” 120, it may be a requirement that an applicant has a valid address. This rule can be defined by using the description 121, type 122, category 123, priority 124 and status 125 categories.

In an embodiment, the maintain requirements and business rules transaction screen 71 is only available or updatable via the application function context menu 42. However, the maintain requirements and business rules transaction screen 71 may also be available to the application system and the application system module via a requirement button.

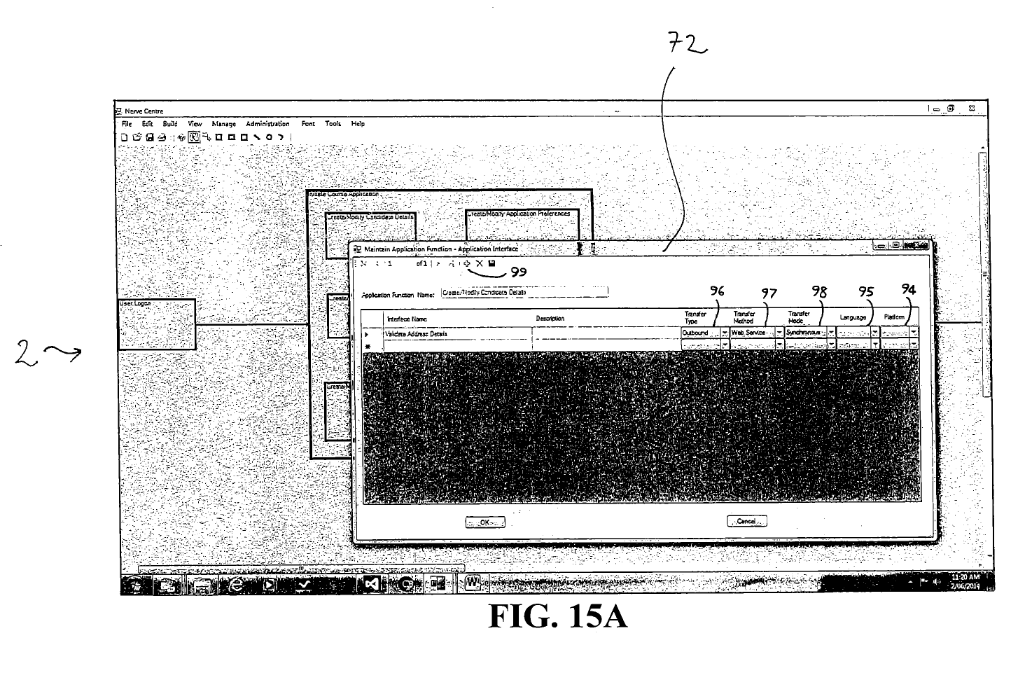

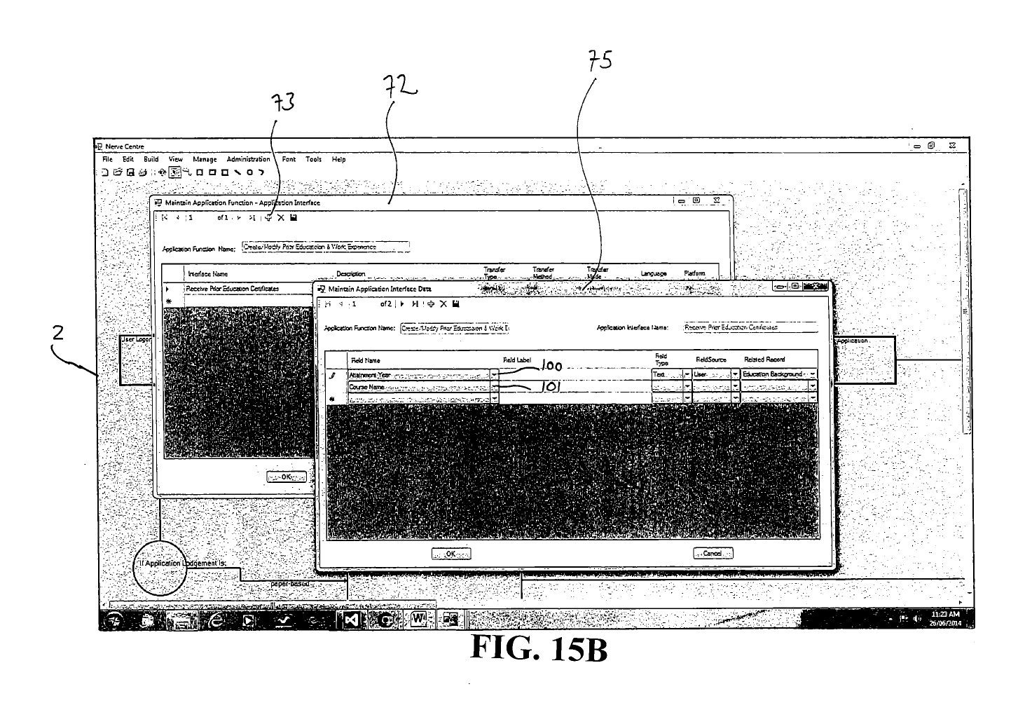

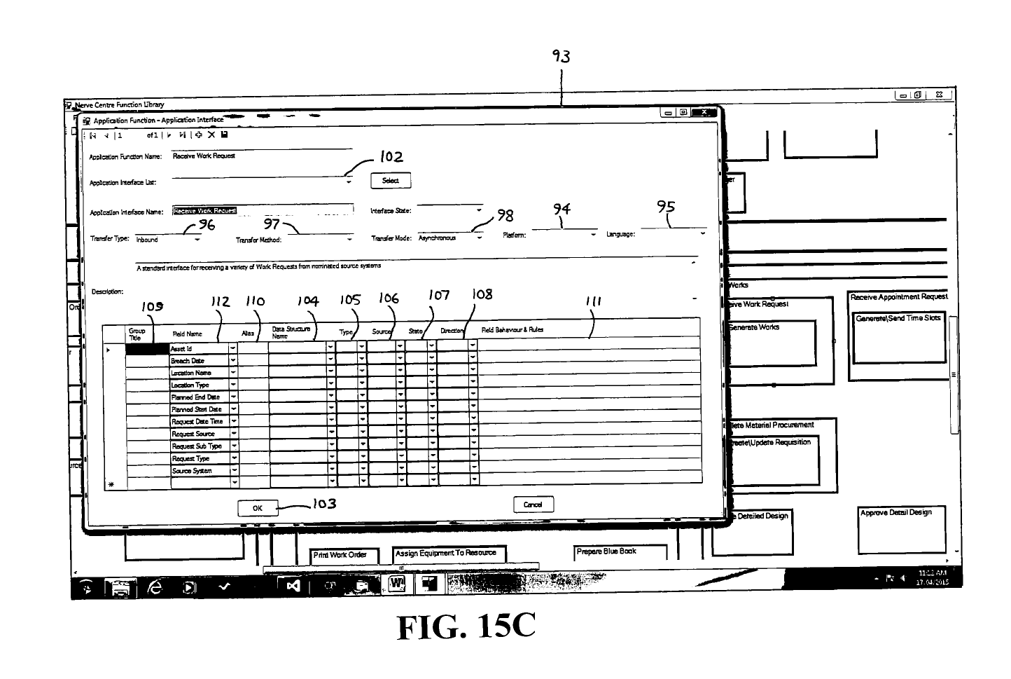

Referring to FIGS. 15a, 15b and 15c, selecting the application interface item 64 may cause the UI 2 to display an application interface transaction screen 72 in FIG. 15a or 93 in FIG. 15c, in which the user can create, edit or delete one or more of the associated fields or attributes, as is illustrated in FIG. 15a. In particular, the application interface transaction screen 72 may allow the user to enter one or more application-to-application interface entries, each specifying a number of attributes for the application function in question, such as: (i) platform 94, e.g. NET, (ii) language 95, e.g. C#, (iii) transfer type 96, e.g. inbound or outbound, (iv) transfer method 97, e.g. web service, and (v) transfer mode 98, e.g., asynchronous. However, any suitable interface attribute may be provided.

Upon selecting to add or modify a field (for example, by clicking on the +symbol 99), The UI 2 may display an application-function interface data transaction screen 75, with which the user can specify particular data fields associated with the corresponding application function. For example, a “create/modify prior education & work experience” application function may require inter alia an attainment year data field 100 and a course name data field 101.

FIG. 15c shows a further example of an application function application interface transaction screen 93 whereby the user can either, select a pre-defined Application Interface Service from the Application Interface List 102, or create a new one, by filling in the attributes, then save by clicking the “OK” button 103. When a new Application Interface is created, it is also added to the Application Interface Service library so that it can be shared with other users.

For each selected Field 112, the user can choose the corresponding:

Data Structure 104 that the field belongs to. When the Field Direction is inbound, it indicates the destination whereas, when it is outbound, it indicates the source Data Structure;

Type 105 that defines the format of the field values (e.g. Text, Check Box, Combo Box, Date etc.);

Source 106 that defines who or what provides the field values (e.g. User, API, System etc.);

Current State 107 that represent the field status in relation to the User Interface (e.g. New, Active, Change, Remove etc.);

Direction 108 that indicates whether the Field is inbound or outbound.

In addition the user can, as required, enter:

Group Title 109 that defines which related Fields are transferred together;

Alias 110 that defines the Field Name 112 in the related Data Structure;

Field Behavior and Rules 111 that defines any relevant validation, transformation and loading rules.

Each Application function may have zero, one or more Application Interface screens.

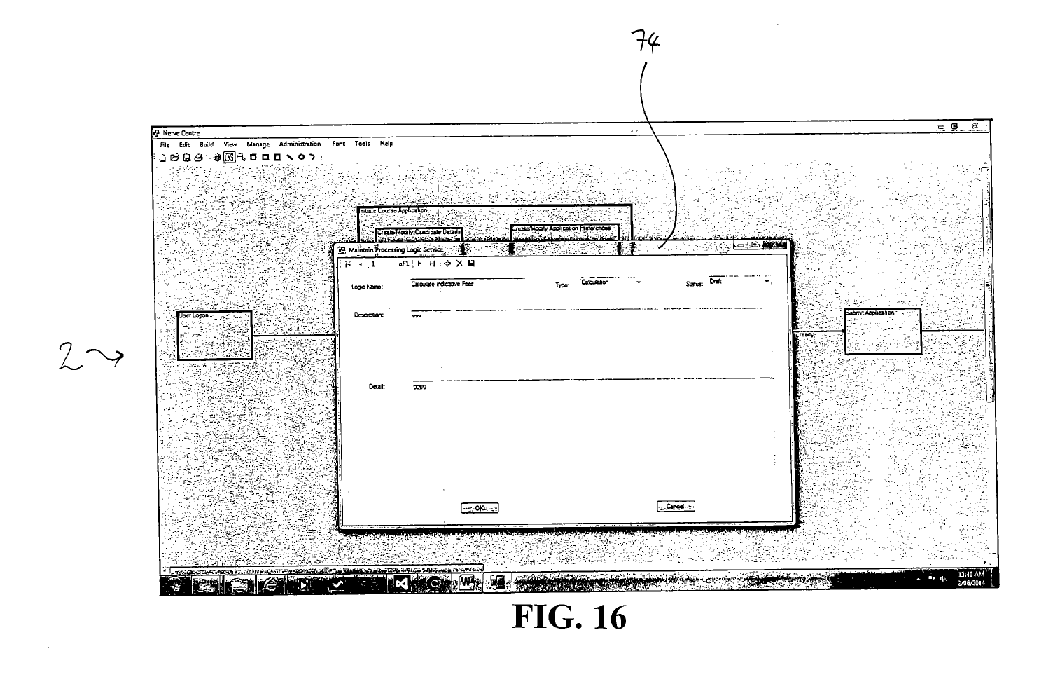

Referring to FIGS. 10, 16 and 17, selecting the processing logic item 66 may cause the UI 2 to display a processing logic transaction screen 74, in which the user may create or edit one or more of the associated fields or attributes, as is illustrated in FIG. 16. For example, an application function may require the calculation of fees for a student enrolling in a course, so that the fee can be displayed to the student during the enrolment process. The processing logic transaction screen 74 may allow the user to enter a name and type of logic (such as a calculation). The processing logic transaction screen 74 also allows the user to define the logic. For example, in calculating a student's fees, the application function may be controlled to add the fee for each paper, resulting in the entire course fee. The logic may take into account other factors such as benefits, scholarships and differences in fees for domestic and international students. (Whether a student is domestic or international may be determined when the student enters their citizenship, as is illustrated by the user interface transaction screen in FIG. 14.)

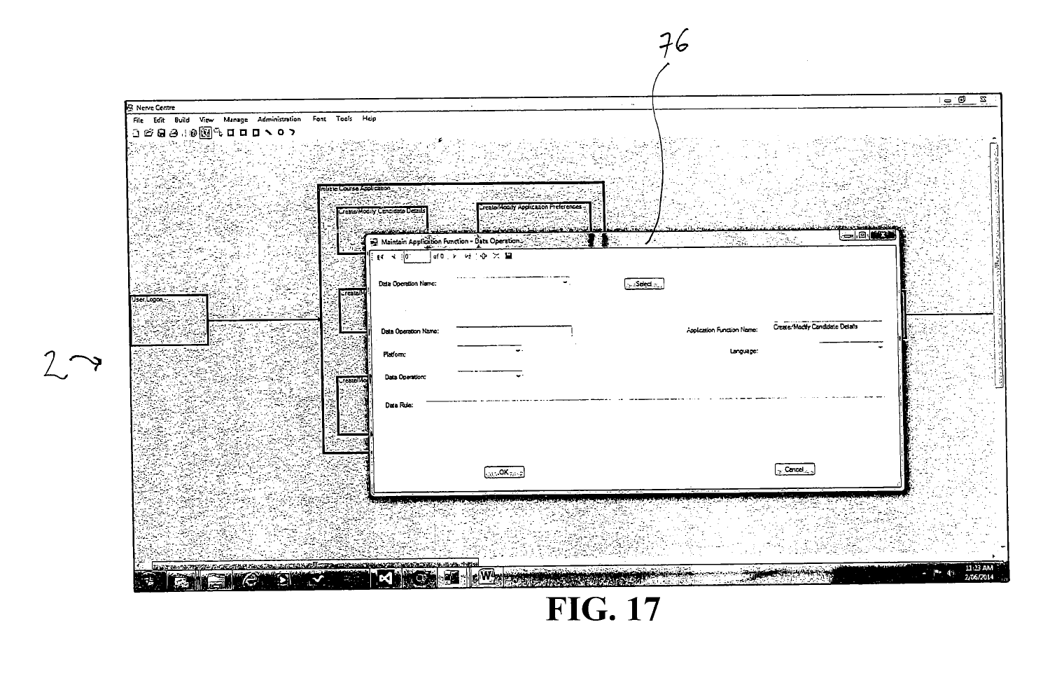

Finally, selecting the data operation item 68 may cause the UI 2 to display a data operation transaction screen 76, in which the user may create or edit one or more of the associated fields or attributes, as is illustrated in FIG. 17. In particular, the data operation transaction screen 76 may allow the user to define a platform, language, data operation and data rule, all of which defines how data generated by or received at that application function 16 is processed or operated on. It is noted that the items of the context menu 42 may be displayed or accessed in any suitable manner.

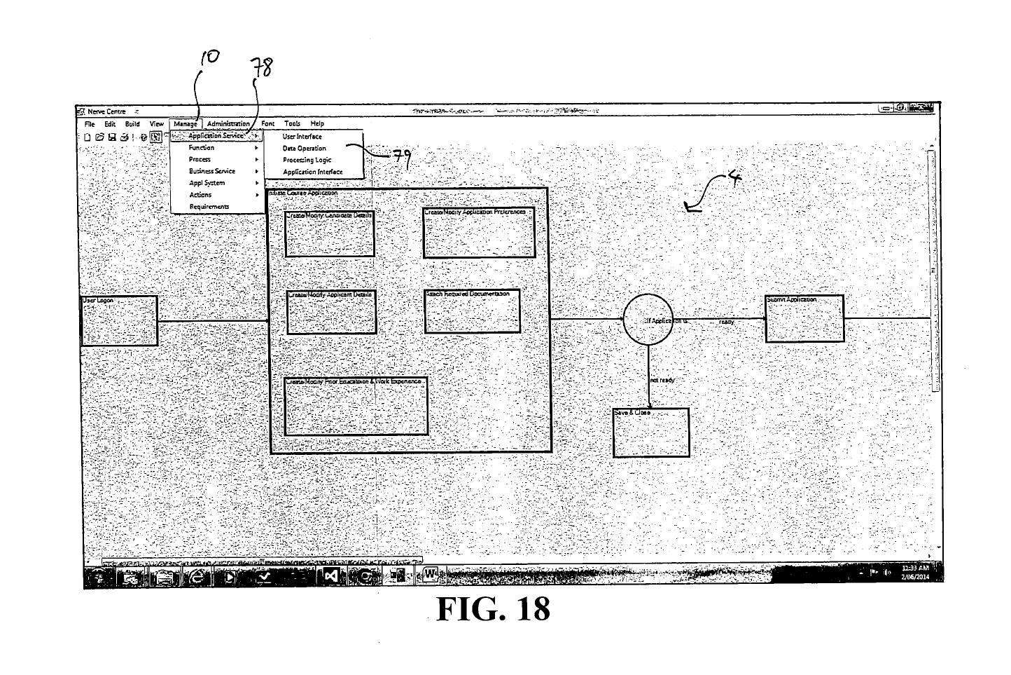

Referring to FIG. 18, the user may alternatively access a data operation service transaction screen, processing logic service transacting screen, application interface service transacting screen or user interface transacting screen, for example, by selecting a corresponding item via the manage menu 10 and an application services sub-menu 78.

The application service item sub-menu 78 may be used to predefine application services, which can be subsequently selected when creating an application sub-function. Alternatively, if an application sub-function is newly created, it is also stored as an application service so that it can be reused by another application function, as needed.

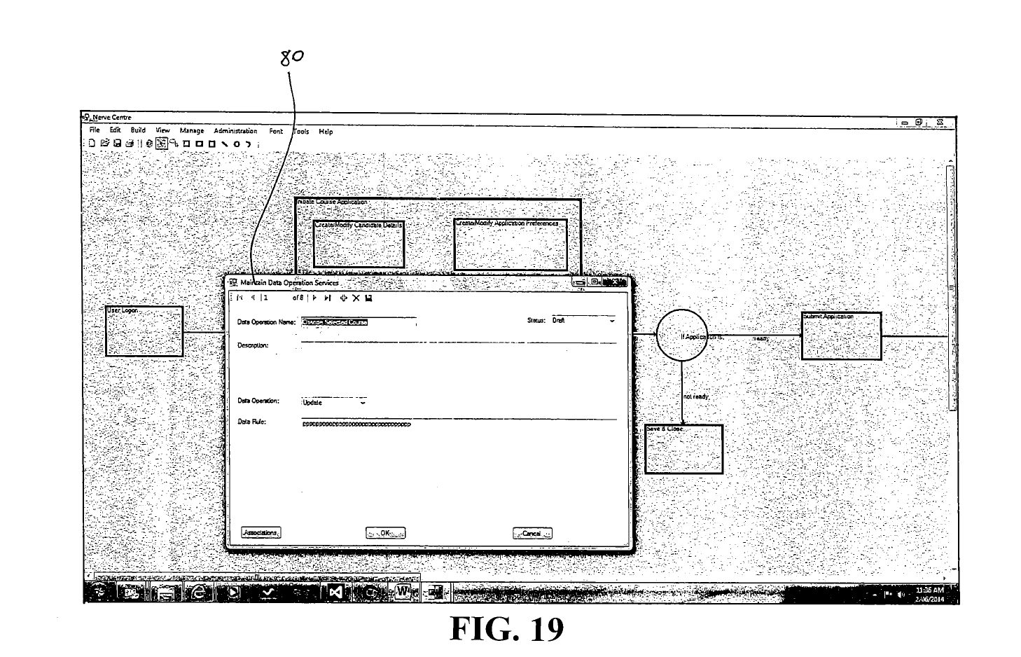

It will be appreciated that such management of the model 4 may be executed in any suitable manner. Referring to FIGS. 18 and 19, selecting the data operation item 79 may cause the UI to display a data operation service transaction screen 80. Once a data operation service is defined, it may be available to be selected and used as a data operation sub-function for any appropriate application function 16.

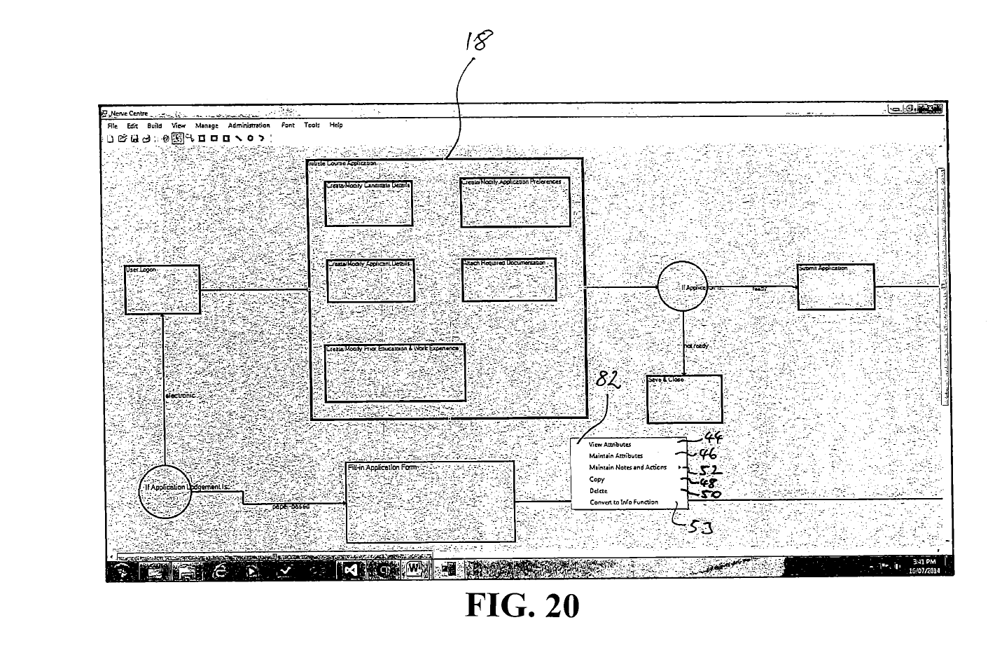

Referring to FIG. 20, right clicking on a business function 18 may cause the UI 2 to display a business function context menu 82 comprising any suitable items or sub-menus. The context menu 82 for the business function 18 may be similar to the context menu for the application function, but typically does not include a maintain application component sub-menu or a maintain requirements item. In particular, the business function context menu 82 may comprise: (i) a view attribute item 44, (ii) a maintain attribute item 46, (iii) a maintain notes and actions sub-menu 52, (iv) a copy item 48, (v) a paste item (only appears in context menu when a shape is copied), and (vi) a delete item 50, which work in a similar manner as described above with regards to the application function 16 context sub-menu 42. Additionally, the business function context menu 82 may comprise a convert to information-based function item 53, which, upon selection, converts the associated business function 18 to an information-based function. Similarly, any other shape, such as a link 20, an information-based function or a decision option may have associated context menus.

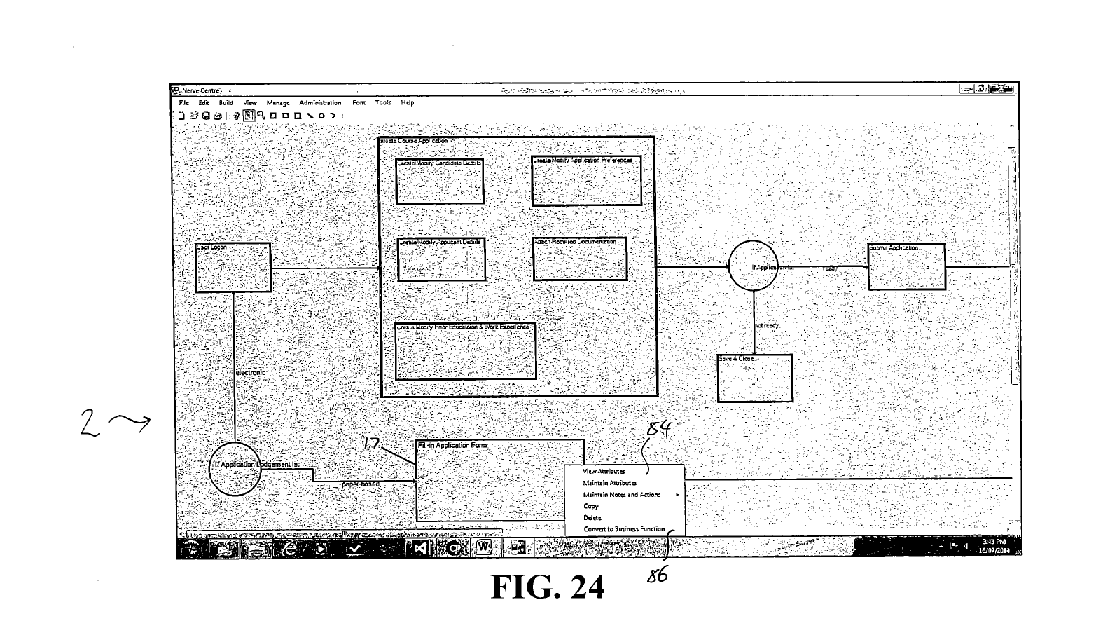

Referring to FIG. 24, right clicking on an information-based function 17 may cause the UI 2 to display an information-based function context menu 84. The information-based function context menu 84 may be similar to the business function context menu (see FIG. 20), but may comprise a convert to business function item 86 (rather than a convert to information-based function item), which, upon selection, converts the associated information-based function 17 to a business function.

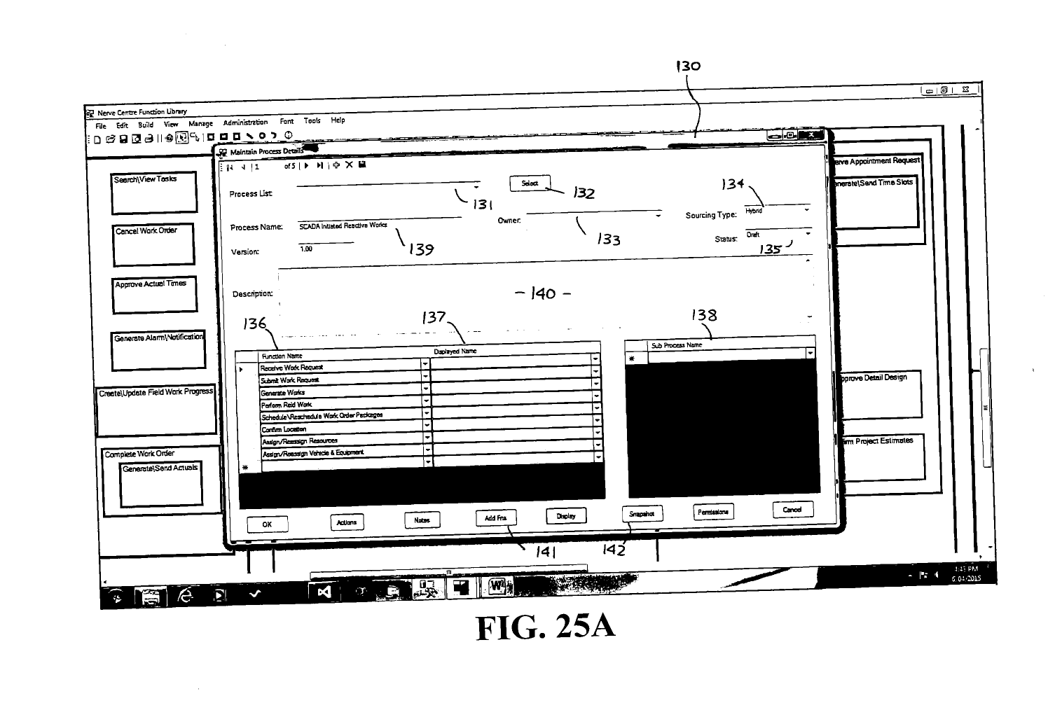

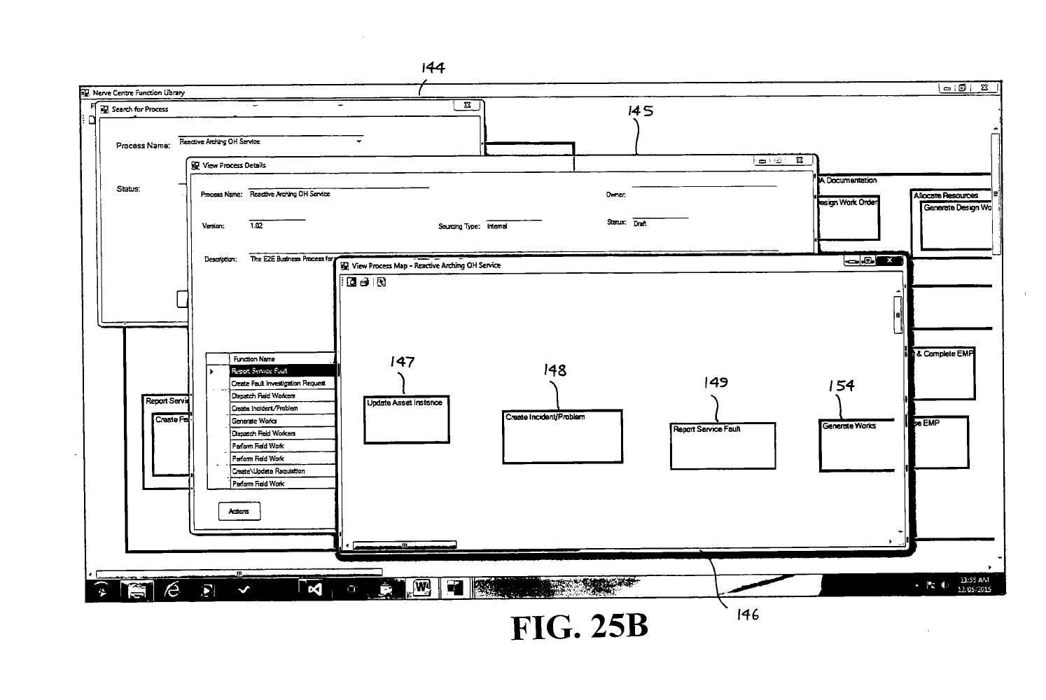

FIG. 25a shows a Maintain Business Process Details transaction screen 130. An authorized user is able to create, update or delete a business process on screen 130. To access an existing business process, the user can find the desired record in the Process List Combo Box 131 and click on the ‘Select’ button 132. The selected business process is only displayed if the user has current access permission. A business process can be made up of all types of functions and other processes. When a user is creating or updating a business process, each transaction provides a pre-defined list of:

Owner 133, a Role that nominally controls and approves changes to the business process;

Sourcing Type 134, where the participants involved in the business process are sourced from;

Status 135, the current lifecycle stage of the business process;

Function Name 136, functions that could be selected to form part of the business process;

Displayed Name (where available) 137, the function name that is displayed on the business process map, and

Sub Process Name 138, other business processes that could be selected to form part of the business process.

The user only needs to enter the business process name at 139, and optionally, description at 140 as and when required.

In addition to selecting a desired function on the business process detail screen 130, there are three other ways a user can add a function to a business process:

Click the ‘Add to Process’ button on a ‘View Function’ screen;

Select a set of functions on the ‘View Function Summary’ screen and click the ‘Add to Process’ button;

Use the multi-select tool to select a set of functions from a Function Library screen, right-click and select the ‘Process’ command.

This brings the user to the business process details screen 130. The user can then select the desired business process and click on the ‘Add Fns’ button 141, which then adds the functions to the business process.

The user is able to search for a particular process by selecting, on screen 144 in FIG. 25b, the business process name, or processes based on the Status value. The user then has access to the View Business Process Details transaction screen 145. A user is able to click on an ‘Actions’ and ‘Notes’ buttons provided on screen 145, to create and assign To Do actions, or maintain notes, context and remarks respectively. A display button is also provided on screen 145, which when clicked, displays graphically the business process map screen 146. The screen 146 includes business functions 147, 149 and 154 as well as application function 148.

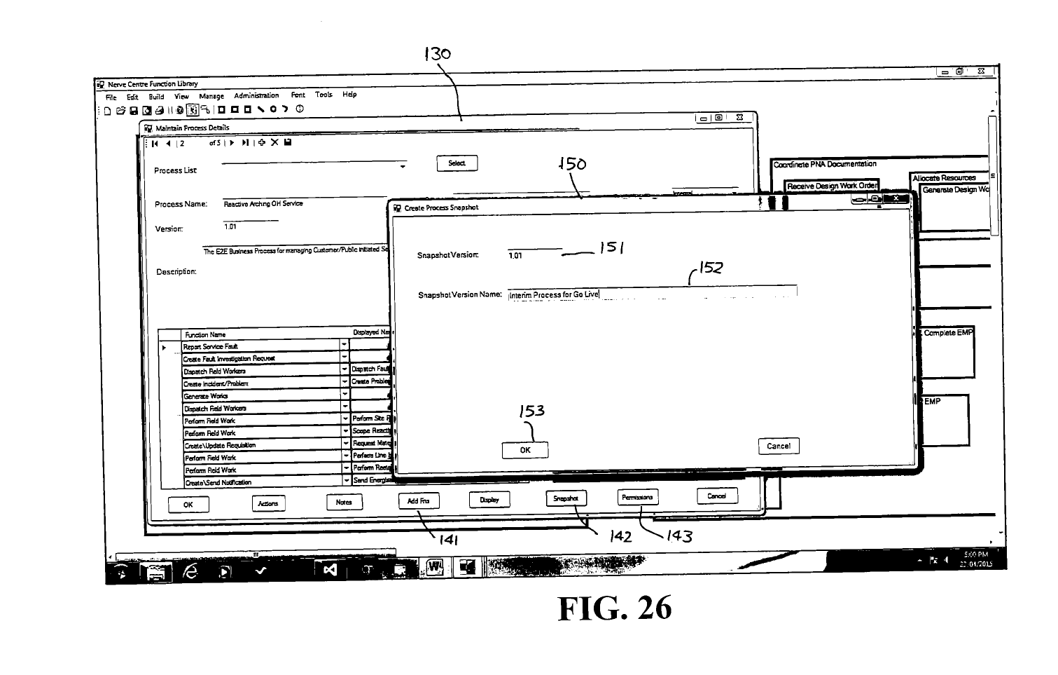

FIG. 26 shows a Create Process Snapshot screen 150 when the ‘Snapshot’ button 142 is clicked. The user is able to create a version of the business process by entering a version number in box 151 and providing a name to the Snapshot version in box 152 and clicking the “OK” button 153. The business process can continue to be modified as required. These versions can subsequently be viewed for historical comparison or options analysis with the current business process.

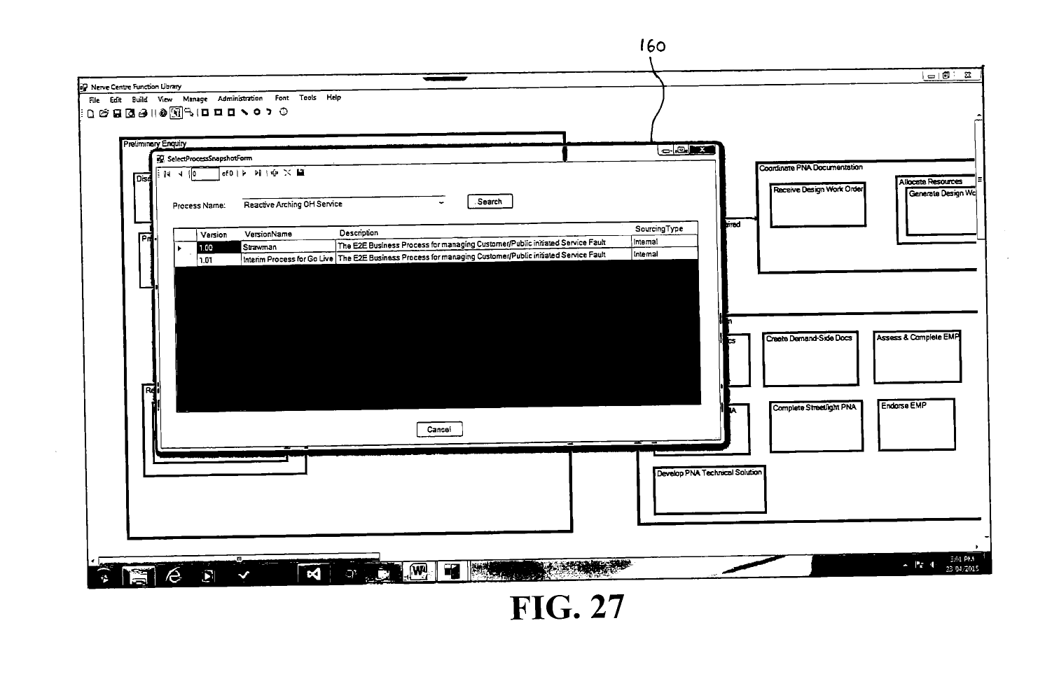

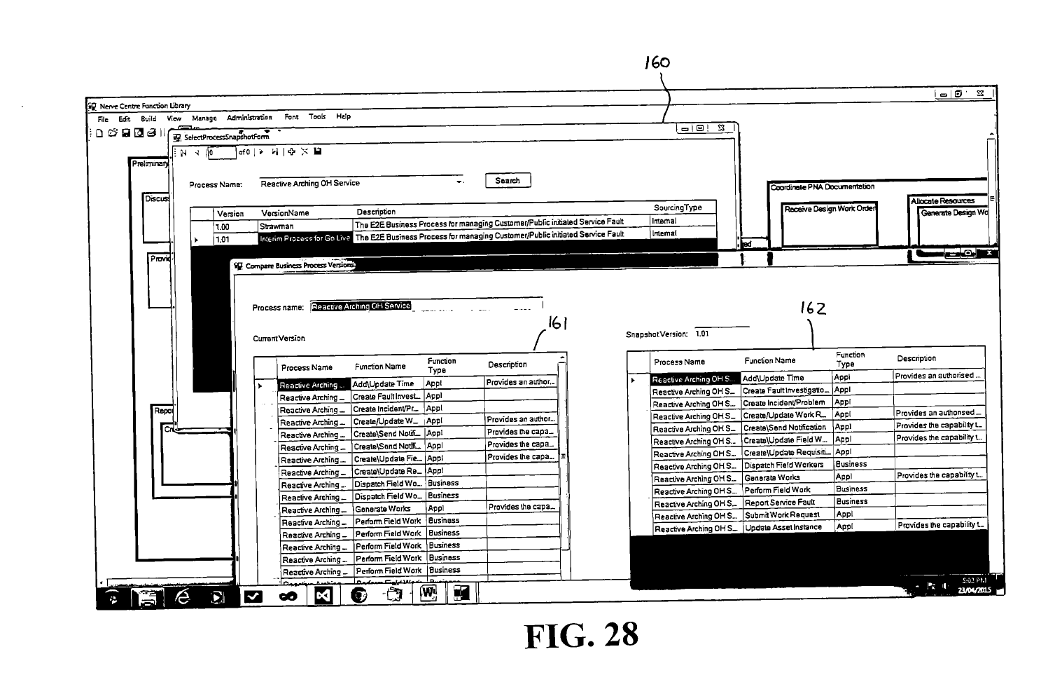

FIG. 27 shows a Select Process Snapshot Form Screen 160 where a snapshot of a particular version of a process can be selected and compared to a current version of the process. Thus in FIG. 28 the process “Reactive Arching OH Service” has been selected and its current version is shown in table 161 and is compared to selected version 1.01 in table 162. Each of the tables 161 and 162 show a process name, a function name, function type and a description.

It is therefore possible to compare versions of a process through these snapshots in time and obtain an historical perspective to view how versions have changed over time. A user can see graphically (side by side comparison) the details in each function or process or roles from months or years in the past and compare these to the present version. It saves a user having to look through different documents or tools which takes longer and can be frustrating and prone to mistakes by the user. It is much easier to compare like products at different times through this particular tool.

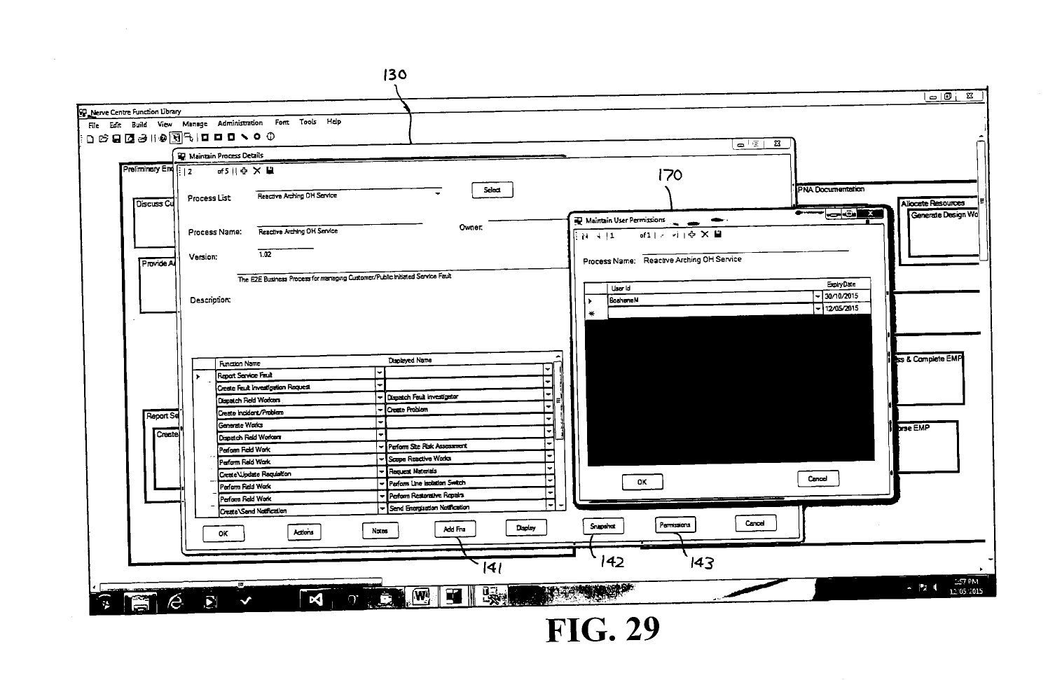

FIG. 29 shows a Maintain User Permissions screen 170 when the “Permissions” button 143 is clicked. By default, the user who creates the business process is the only one who can update it. The user is however, able to grant other users permission for a defined period, to update the business process as well.

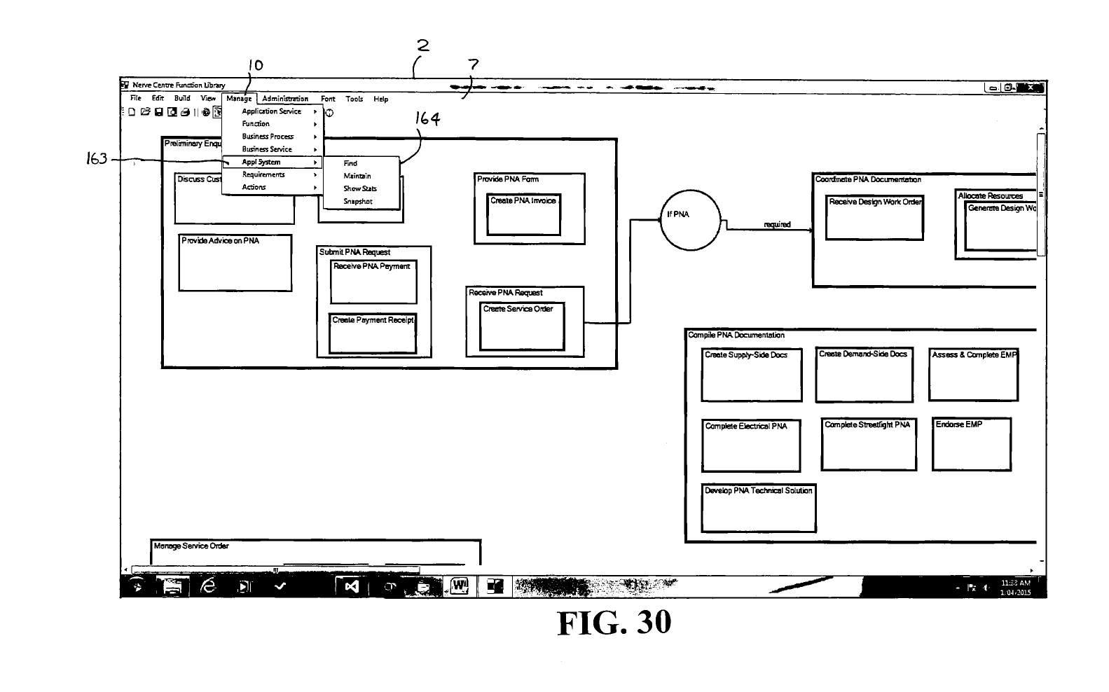

Referring to FIG. 30, a user can use the menu bar 7 and select manage menu 10 to access the application system sub-menu 163. From there a list of application sub-menu items 164 is produced whereby the user can access the “Find”, “Maintain”, “Show Stats” and “Snapshot” items. Using the “Find” item, the user is able to search for a particular application system or module by selecting the application system or module name respectively. From the screen presented, the user can view the application system details transaction screen. From the application system details transaction screen, a user can click on respective buttons to view Notes, a To-Do List, Actions, Requirements (and Business Rules) and Show Stats.

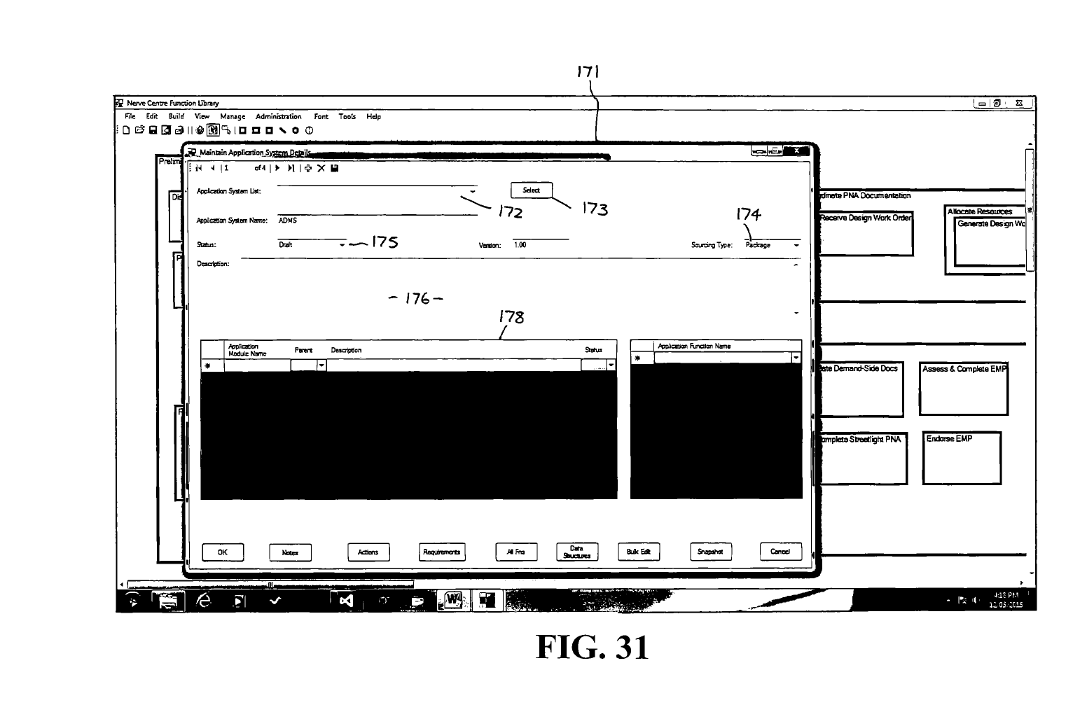

FIG. 31 shows a Maintain Application System transaction screen 171. An authorized user is able to create, update or delete an application system on screen 171. An application system consists of one or more modules however, in situations where particular application functions are available across modules, the user is able to select and associate the functions at the system level. To access an existing application system, the user can find the desired record in the application system list combo box 172 and click on the ‘Select’ button 173. When a user is creating or updating an application system, each transaction provides a pre-defined list of:

sourcing type—where the participants involved in the business process are sourced from;

status—the current lifecycle stage of the Business Process.

The user only needs to enter the application system name at box 175, and, optionally, a description in box 176 as and when required. In addition, the user is able to enter details of the application modules and also, select any cross-module application functions. The user can click on the buttons below (at the bottom of screen 171) to maintain additional details.

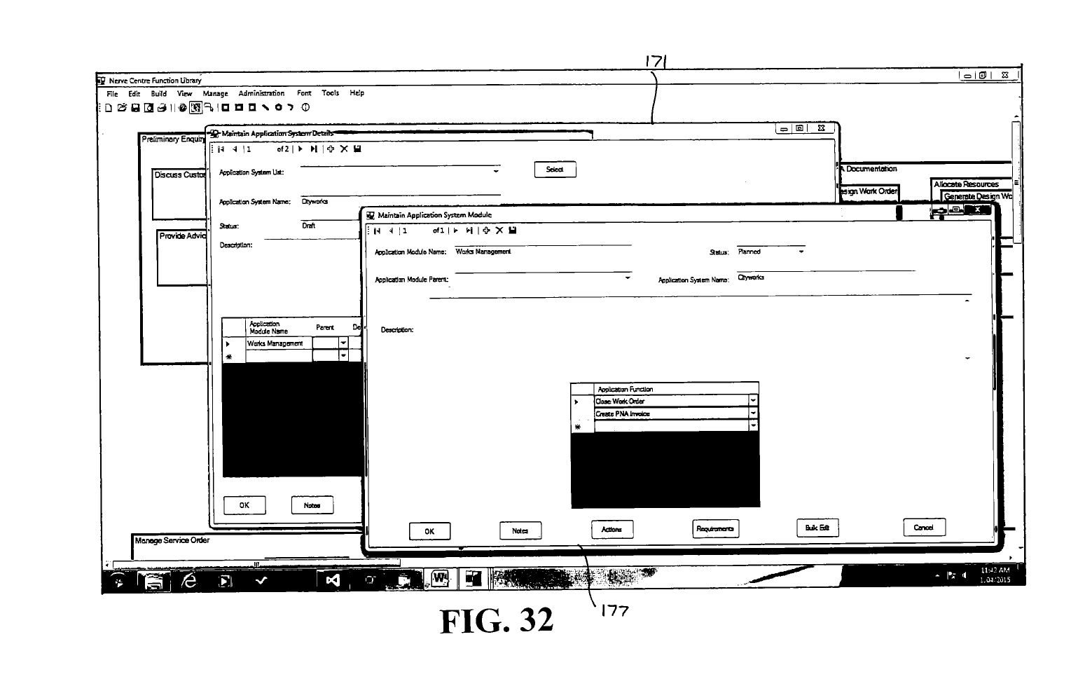

Double clicking on a desired application module name in box 178 of screen 171 enables access to the application system module screen 177 shown in FIG. 32. A module may be hierarchically associated with another module. Access is provided through buttons at the bottom of screen 177 to “Notes”, “Actions”, “Requirements” and a “Bulk Edit” associated with the application system module.

Ultimately, the function-based system modeling tool provides a UI 2 so that a user can build a model 4 of a system or process. The model 4 can allow the user to organize the functions and elements in several levels of granularity (such as six) to depict a hierarchy of functional relationships.

The function-based system modeling tool is arranged to generate a number of outputs or documents based on the model 4. For example, the function-based system modeling tool may output a software specification document for a software developer that may be used in designing and building or evaluating software related to a modeled process. The function-based system modeling tool may output a specification for database design for a database developer that is based on the types of data and the relationships between the data specified in the model.

The function-based system modeling tool may output a specification for an application interface for use by an integration developer that is based on the interfaces defined in the application functions in the model 4. The function-based system modeling tool may output a process model document for use by business managers and change managers to better understand how business functions and processes are aligned to application functions. A process model may also be used to analyze the business process, for example, to find areas of potential improvement. It should be noted that the function-based system modeling tool may be arranged to generate any suitable output or document.

The function-based system modeling tool is typically implemented using software but alternatively may be implemented using hardware or a combination of software and hardware. The function-based system modeling tool may be implemented using any suitable computer program code or any suitable programming language. The computer program code is typically stored on a computer readable medium such as a hard disk drive (HDD) or random access memory (RAM).

The function-based system modeling tool may be advantageous in that it enables or provides for the creation and maintenance of specific element values (i.e. building blocks). Such values can subsequently be selected to define each component function. The function-based system modeling tool may also be advantageous in that it enables the creation and maintenance of unique component functions that can be reused in any number of modeled processes or systems.

The function-based system modeling tool may be advantageous in that it enables or provides for the definition, modeling and management of hierarchically aligned component functions, as well as inter-connected processes and application systems in one tool or system. The function-based system modeling tool may be advantageous in that it enables the traceability of an element or component function in all modeled processes or systems of which they form a part.

The function-based system modeling tool may be advantageous in that it enables or provides the output of a specification of requirements at an appropriate level of granularity. This may apply to a specific application function, application system module or the whole application system. The function-based system modeling tool may be advantageous in that it enables analysis of the process or system models based on their elements and functional components. The function-based system modeling tool may be advantageous in that it enables comparison and analysis of past, current and planned process or system models and business services.

The function-based system modeling tool and method may be advantageous in that it may reduce or eliminate the prevalence of unintended variations between organizations' expectations and actual outcomes when relying on the current business process management and IT software design knowledge base and tools. The function-based system modeling tool and method may do so by improving the quality of analysis and design artefacts, prior to acquiring (whether through development or purchase) the proposed application systems.

It will be understood to persons skilled in the art of the invention that many modifications may be made without departing from the spirit and scope of the invention.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that such prior art forms a part of the common general knowledge in the art, in Australia or any other country.

What is claimed:

1. A modeling system for modeling a process or system comprising:
a processor arranged to execute a user-interface module and to receive input commands from a user,
wherein the user-interface module facilitates the building of a model from the input commands, wherein the model includes: (i) a plurality of hierarchical functions, wherein each function comprises one or more elements, wherein each function represents part of the process or system, and wherein each element is reproducible in more than one function, and (ii) one or more sequence-indicating links between functions that indicate a flow between the functions comprising the process or system,
wherein the processor is arranged to control a display device to display the model to the user,
wherein the modeling system is arranged to store data indicative of the model on a storage device; and
wherein the modeling system is arranged to generate and output a document based on the model.

2. A modeling system as claimed in claim 1, wherein the model includes one or more decision options.

3. A modeling system as claimed in claim 1, wherein each function is a business function, an application function, or an information-based function.

4. A modeling system as claimed in claim 3, wherein a business function comprises at least one action element and at least one participant element.

5. A modeling system as claimed in claim 4, wherein a business function comprises at least one data element or at least one resource element or both.

6. A modeling system as claimed in claim 3, wherein an application function comprises at least one data element and at least one action element.

7. A modeling system as claimed in claim 3, wherein an application function includes components comprising any combination of a user interface, an application interface, a data operation, and processing logic.

8. A modeling system as claimed in claim 3, wherein an information-based function comprises at least one action element, at least one participant element, and at least one data element.

9. A modeling system as claimed in claim 3, wherein an information-based function comprises at least one resource element.

10. A modeling system as claimed in claim 3, wherein the user-interface module facilitates six levels of granularity for business functions.

11. A modeling system as claimed in claim 1, wherein the output is a software specification document, a specification for database design, a specification for an application system, or a process model document.

12. A modeling system as claimed in claim 3, wherein one or more requirements or rules are defined at an application function, an application system or an application system module level.

13. A modeling system as claimed in claim 3, wherein an application function component comprises a reusable application service.

14. A modeling system as claimed in claim 3 wherein any one of said business function, said application function, or said information-based function has at least one sub-function which represents a subset of the respective function's capabilities.

15. A modeling method for modeling a process or system comprising:
executing a user-interface module and receiving input commands from a user at a processor;
building at the user-interface module a model from the input commands, wherein the model includes: (i) a plurality of hierarchical functions, wherein each function comprises one or more elements, wherein each function represents part of the process or system, and wherein each element is reproducible in more than one function, and (ii) one or more sequence-indicating links between functions that indicate a flow between the functions comprising the process or system;
controlling a display device to display the model to the user;
storing data indicative of the model on a storage device; and
generating and outputting a document based on the model.

16. A modeling method as claimed in claim 15, wherein the model includes one or more decision options.

17. A modeling method as claimed in claim 15, wherein each function is a business function, an application function, or an information-based function.

18. A modeling method as claimed in claim 17, wherein a business function comprises at least one action element and at least one participant element.

19. A modeling method as claimed in claim 18, wherein a business function comprises at least one data element or at least one resource element or both.

20. A modeling method as claimed in claim 17, wherein an application function comprises at least one data element and at least one action element.

21. A modeling method as claimed in claim 17, wherein an application function includes components comprising any combination of a user interface, an application interface, a data operation, and processing logic.

22. A modeling method as claimed in claim 17, wherein an information-based function comprises at least one action element, at least one participant element, and at least one data element.

23. A modeling method as claimed in claim 17, wherein an information-based function comprises at least one resource element.

24. A modeling method as claimed in claim 15, wherein the user-interface module facilitates six levels of granularity for business functions.

25. A modeling method as claimed in claim 15, wherein the output is a software specification document, a specification for database design, a specification for an application system, or a process model document.

26. A modeling method as claimed in claim 15, wherein one or more requirements or rules are defined at an application function, an application system or an application system module.

27. A modeling method as claimed in claim 15, wherein an application function component comprises a reusable application service.

28. A computer program adapted to control a computing device to implement the method of claim 15.

29. A computer readable medium comprising a computer program as claimed in claim 28.
